(19) United States
(12) Patent Application Publication
(10) Pub. No.: US 2026/0303842 A1
(43) Pub. Date: Oct. 1, 2026

(54) MULTILAYER BITSTREAMS ALLOWING PROCESSING OF TWO OR MORE OUTPUT FRAMES PER TIME INSTANCE FROM A TRACK IN A FILE FORMAT

(71) Applicant: Nokia Technologies Oy, Espoo (FI)

(72) Inventors: Kashyap KAMMACHI SREEDHAR, Tampere (FI); Lukasz KONDRAD, Munich (DE); Miska Matias HANNUKSELA, Tampere (FI); Lauri Aleksi ILOLA, Tampere (FI); Emre Baris AKSU, Tampere (FI)

(21) Appl. No.: 19/572,314

(22) Filed: Mar. 19, 2026

Related U.S. Application Data
(63) Continuation-in-part of application No. 18/894,607, filed on Sep. 24, 2024.
(60) Provisional application No. 63/585,541, filed on Sep. 26, 2023.

(51) Int. Cl. H04N 19/30; H04N 19/172; H04N 19/70

(52) U.S. Cl. CPC H04N 19/30; H04N 19/172; H04N 19/70

(57) ABSTRACT

In a process for coding a multilayer bitstream into a box structured file having video information from video, supplemental information is placed into a box of the box structured file. The box stores metadata for the video information, and the supplemental information can be used to process two or more output frames per time instance of the video from a track of the box structured file. The box structured file is output as at least as an encapsulated file. In a process for parsing a box structured file into a multilayered bitstream, where the box structured file has video information from video, supplemental information is accessed from a box, in the box structured file, storing metadata for the video information. The supplemental information can be used to process two or more output frames per time instance of the video from a track of the box structured file.

### CROSS-REFERENCE TO RELATED APPLICATIONS

The present application claims the benefit under 35 U.S.C. § 119(e) of U.S. Provisional Patent Application No. 63/777,190, filed on Mar. 25, 2025, the disclosure of which is hereby incorporated by reference in its entirety. Any and all applications for which a foreign or domestic priority claim is identified in the Application Data Sheet of the present application are hereby incorporated by reference under 37 CFR § 1.57.

### TECHNICAL FIELD

Examples of embodiments herein relate generally to video coding and decoding and, more specifically, relate to information in file formats for multilayer bitstreams for video coding and decoding.

### BACKGROUND

Encoded video, such as by using an encapsulated file, may be placed into a bitstream, and a decoder may decode the encoded video from the bitstream. A simple way of encoding video is to encode input video into a single (base) layer for placing into the bitstream. That is, the information in the base layer corresponds to the video and no enhancement or other information is used.

A multilayer bitstream, however, is also used at times, where more information is provided. For instance, in addition to the base layer, an “enhancement” layer may be provided with additional information that enhances the video quality when received and decoded together with the base layer. There may be multiple such enhancement layers. An enhancement layer may enhance, for example, the temporal resolution (i.e., the frame rate), the spatial resolution, or simply the quality of the video content represented by another layer or part thereof. It is also possible to have two (or more) views of the same scene, which leads to, multiple layers and a multi/layer bitstream. Another possibility is to have auxiliary data, for example depth map or alpha map of the content, in the base layer, leading to multiple layers and a multilayer bitstream. Improvements could be made for these multilayer bitstreams.

### BRIEF SUMMARY

This section is intended to include examples and is not intended to be limiting.

According to some aspects, there is provided the subject matter of the independent claims. Some further aspects are defined in the dependent claims.

### BRIEF DESCRIPTION OF THE DRAWINGS

The accompanying drawings use reference numerals, where the same reference numerals may be used to refer to like parts throughout, but parts having the same reference numeral can differ in operation and components. In the attached drawings:

FIG. 1 is a block diagram illustrating a system in accordance with an example;

FIG. 2, which is split into FIGS. 2A and 2B, illustrates a multilayer VVC encoder which may be used to realize the examples herein;

FIG. 3, which is split into FIGS. 3A and 3B, illustrates a multilayer VVC decoder which may be used to realize the examples herein;

FIG. 4 is a flow diagram of a process for coding a multilayer bitstream into a box structured file supporting the multilayer bitstream and allowing processing of two or more output frames per time instance from a track in a file format;

FIG. 5 is a flow diagram of a process for parsing a box structured file into a multilayer bitstream and allowing processing of two or more output frames per time instance from a track in a file format;

FIG. 6 is a block diagram of an ISO file and a relationship to a sample entry of VisualSampleEntry used in an example; and

FIG. 7 is an example of a block diagram of an apparatus suitable for implementing any of the encoders or decoders described herein.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this detailed description are exemplary embodiments provided to enable persons skilled in the art to make or use the examples. When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It is noted that capital and lowercase words or phrases are considered to be the same herein. For instance, the words Slice, slice, and SLICE are the same, as are the phrases Network Repository Function, network repository function, and NETWORK REPOSITORY FUNCTION. Any flow diagram or signaling diagram herein is considered to be a logic flow diagram, and illustrates the operation of an exemplary method, results of execution of computer program instructions embodied on a computer readable memory, and/or functions performed by logic implemented in circuitry. For methods, flow diagrams, and signaling diagrams, the orders of method steps, blocks in the flow, or signaling are not critical and instead are examples.

Technical context is now provided for technical areas related to the understanding of the examples. This is provided as brief overviews of possibly related technical areas.

Multi-layer coding enables coding of multiple layers for different applications and use cases. Multilayer bitstream may be stored in ISOBMFF (ISO base media file format, where ISO is International Organization for Standardization or International Standards Organization) files with the following ways.

1) Single-track storage which is backward-compatible: This approach maintains compatibility with legacy devices which support parsing and decoding of only the base layer by using the base layer codec as the primary identifier.

2) Single-track storage which is non-backward-compatible: This scenario uses the enhancement layer codec as the primary identifier, which may offer for example, better quality but sacrifices compatibility with older devices.

3) Multi-track storage: This method separates different layers into distinct tracks, offering clear separation but potentially increasing complexity in client logic.

When multilayer bitstream is stored in an ISOBMFF file, there are many ISOBMFF boxes (box structures) which are present in the file which do not specify the mapping to different layers in an unambiguous way. This is one problem that is addressed herein.

An introduction to the ISO base media file format is presented now. Available media file format standards include International Standards Organization (ISO) base media file format (ISO/IEC 14496-12, which may be abbreviated ISOBMFF), Moving Picture Experts Group (MPEG)-4 file format (ISO/IEC 14496-14, also known as the MP4 format), file format for NAL (Network Abstraction Layer) unit structured video (ISO/IEC 14496-15) for example, the High Efficiency Video Coding standard (HEVC or H.265/IEVC).

Some concepts, structures, and specifications of ISOBMFF are described below as an example of a container file format, based on which some embodiments may be implemented. The aspects of this document are not limited to ISOBMFF, but rather the description is given for one possible basis on top of which at least some embodiments may be partly or fully realized.

A basic building block in the ISO base media file format is called a box. Each box has a header and a payload. The box header indicates the type of the box and the size of the box in terms of bytes. Box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames. For video tracks, a media sample may correspond to a coded picture or an access unit.

A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleDescriptionBox, which gives detailed information about the coding type used, and any initialization information needed for that coding. The SampleDescriptionBox contains an entry-count and as many sample entries as the entry-count indicates. The format of sample entries is track-type specific but derived from generic classes (e.g., VisualSampleEntry, AudioSampleEntry). Which type of sample entry form is used for derivation of the track-type specific sample entry format is determined by the media handler of the track.

The track reference mechanism can be used to associate tracks with each other. The TrackReferenceBox includes box(es), each of which provides a reference from the containing track to a set of other tracks. These references are labeled through the box type (e.g., the four-character code of the box) of the contained box(es).

In ISOBMFF, an edit list provides a mapping between the presentation timeline and the media timeline. Among other things, an edit list provides for the linear offset of the presentation of samples in a track, provides for the indication of empty times and provides for a particular sample to be dwelled on for a certain period of time. The presentation timeline may be accordingly modified to provide for looping, such as for the looping videos of the various regions of the scene. One example of the box that includes the edit list, the EditListBox, is provided below:

```
aligned(8) class EditListBox extends FullBox(‘elst’, version, flags) {
  unsigned int(32) entry_count;
  for (i=1; i <= entry_count; i++) {
    if (version==1) {
      unsigned int(64) segment_duration;
      int(64) media_time;
    } else { // version==0
      unsigned int(32) segment_duration;
      int(32) media_time;
    }
    int(16) media_rate_integer;
    int(16) media_rate_fraction = 0;
  }
}
```

In ISOBMFF, an EditListBox may be contained in EditBox, which is contained in TrackBox (‘trak’).

In this example of the edit list box, flags specify the repetition of the edit list. By way of example, setting a specific bit within the box flags (the least significant bit, i.e., flags & 1 in ANSI-C notation, where & indicates a bit-wise AND operation) equal to 0 specifies that the edit list is not repeated, while setting the specific bit (i.e., flags & 1 in ANSI-C notation) equal to 1 specifies that the edit list is repeated. The values of box flags greater than 1 may be defined to be reserved for future extensions. As such, when the edit list box indicates the playback of zero or one sample, (flags & 1) shall be equal to zero. When the edit list is repeated, the media at time 0 resulting from the edit list follows immediately the media having the largest time resulting from the edit list such that the edit list is repeated seamlessly.

In ISOBMFF, a Track group enables grouping of tracks based on certain characteristics or the tracks within a group have a particular relationship. Track grouping, however, does not allow any image items in the group.

The syntax of TrackGroupBox in ISOBMFF is as follows:

```
  aligned(8) class TrackGroupBox extends Box(‘trgr’){ }
  aligned(8) class TrackGroupTypeBox(unsigned int(32) track_group_type)
extends FullBox(track_group_type, version = 0, flags = 0) {
    unsigned int(32) track_group_id;
    // the remaining data may be specified for a particular track_group_type
  }
```

The “id” indicates an identification. track_group_type indicates the grouping_type and shall be set to one of the following values, or a value registered, or a value from a derived specification or registration:

‘msrc’ indicates that this track belongs to a multi-source presentation. The tracks that have the same value of track_group_id within a TrackGroupTypeBox of track_group_type ‘msrc’ are mapped as being originated from the same source. For example, a recording of a video telephony call may have both audio and video for both participants, and the value of track_group_id associated with the audio track and the video track of one participant differs from value of track_group_id associated with the tracks of the other participant.

The pair of track_group_id and track_group_type identifies a track group within the file. The tracks that contain a particular TrackGroupTypeBox having the same value of track_group_id and track_group_type belong to the same track group.

The Entity grouping is similar to track grouping but enables grouping of both tracks and image items in the same group.

The syntax of EntityToGroupBox in ISOBMFF is as follows.

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
}
```

group_id is a non-negative integer assigned to the particular grouping that shall not be equal to any group_id value of any other EntityToGroupBox, any item_ID value of the hierarchy level (file, movie. or track) that contains the GroupsListBox, or any track_ID value (when the GroupsListBox is contained in the file level).

num_entities_in_group specifies the number of entity_id values mapped to this entity group.

entity_id is resolved to an item, when an item with item_ID equal to entity_id is present in the hierarchy level (file, movie, or track) that contains the GroupsListBox, or to a track, when a track with track_ID equal to entity_id is present and the GroupsListBox is contained in the file level.

Video tracks use VisualSampleEntry. The width and height in the video sample entry document the pixel counts that the codec will deliver; this enables the allocation of buffers. Since these are counts they do not take into account pixel aspect ratio.

```
class VisualSampleEntry(codingname) extends SampleEntry (codingname)
  {
    unsigned int(16) pre_defined = 0;
    const unsigned int(16) reserved = 0;
    unsigned int(32) pre_defined[3] = 0;
    unsigned int(16) width;
    unsigned int(16) height;
    template unsigned int(32) horizresolution = 0x00480000; // 72 dpi
    template unsigned int(32) vertresolution = 0x00480000; // 72 dpi
    const unsigned int(32)reserved = 0;
    template unsigned int(16) frame count = 1;
    uint(8) compressorname[32];
    template unsigned int(16) depth = 0x0018;
    int(16) pre_defined = −1;
    // other boxes from derived specifications
```

| | |
|---|---|
| CleanApertureBox clap; | // optional |
| PixelAspectRatioBox pasp; | // optional |

}

Resolution fields give the resolution of the image in pixels-per-inch, as a fixed 16.16 number. The fractional numbers (usually stored in 32 bits fixed variables) are represented (in hex) using the “16.16” format.

frame_count indicates how many frames of compressed video are stored in each sample. The default is 1, for one frame per sample; it may be more than 1 for multiple frames per sample

compressorname is a name, for informative purposes. It is formatted in a fixed 32-byte field, with the first byte set to the number of bytes to be displayed, followed by that number of bytes of displayable data encoded using UTF-8, and then padding to complete 32 bytes total (including the size byte). The field may be set to 0.

Depth takes one of the following values:
0x0018—images are in color with no alpha;
width and height are the maximum visual width and height of the stream described by this sample entry, in pixels.

The pixel aspect ratio and clean aperture of the video are specified using the PixelAspectRatioBox and CleanApertureBox sample entry boxes, respectively. These are both optional; if present, they over-ride the declarations (if any) in structures specific to the video codec, which structures should be examined if these boxes are absent. For maximum compatibility, these boxes should follow, not precede, any boxes defined in or required by derived specifications.

The PixelAspectRatioBox is informative; if the decoded output of the codec is re-formatted to the dimensions in the track header, this will accomplish any needed adjustment to a uniformly-scaled grid.

In the PixelAspectRatioBox, hSpacing and vSpacing have the same units, but those units are unspecified: only the ratio matters. hSpacing and vSpacing may or may not be in reduced terms, and they may reduce to 1/1. Both of them are strictly positive.

The pixel aspect ratio should not be confused with the picture aspect ratio, also known as the display aspect ratio, which is the ratio of the width to the height of the final displayed image (e.g., 16:9).

They are defined as the aspect ratio of a pixel, in arbitrary units. If a pixel appears H wide and V tall, then hSpacing/vSpacing is equal to H/V. This means that a square on the display that is n pixels tall needs to be n*vSpacing/hSpacing pixels wide to appear square.

There are notionally four values in the CleanApertureBox. These parameters are represented as a fraction N/D. The fraction may or may not be in reduced terms. We refer to the pair of parameters fooN and fooD as foo. For horizOff and vertOff, D shall be strictly positive and N may be positive or negative. For cleanApertureWidth and cleanApertureHeight, N shall be positive and D shall be strictly positive.

These are fractional numbers for several reasons. First, in some systems the exact width after pixel aspect ratio correction is integral, not the pixel count before that correction. Second, if video is resized in the full aperture, the exact expression for the clean aperture might not be integral. Finally, because this is represented using center and offset, a division by two is needed, and so half-values can occur.

The relation of width and height of the VisualSampleEntry, the horizontal and vertical coordinates of the picture center of the image denoted as pcX and pcY respectively, and horizOff and vertOff is defined as follows: pcX=horizOff+(width−1)/2; pcY=vertOff+(height−1)/2.

Typically, horizOff and vertOff are zero, so the image is centered about the picture center.

$$The leftmost / rightmost pixel and the topmost / bottommost line of the clean aperture fall at : pcX \pm ( cleanApertureWidth - 1 ) / 2 ; \\ pcY \pm ( cleanApertureHeight - 1 ) / 2.$$

The cropping implied by the CleanApertureBox is applied before any transformation defined by track or movie matrices.

```
class PixelAspectRatioBox extends Box(‘pasp’)
  {
    unsigned int(32) hSpacing;
    unsigned int(32) vSpacing;
  }
```

```
class CleanApertureBox extends Box(‘clap’)
  {
    unsigned int(32) cleanApertureWidthN;
    unsigned int(32) cleanApertureWidthD;
    unsigned int(32) cleanApertureHeightN;
    unsigned int(32) cleanApertureHeightD;
    signed int(32) horizOffN;
    unsigned int(32) horizOffD;
    signed int(32) vertOffN;
    unsigned int(32) vertOffD;
  }
```

hSpacing, vSpacing: define the relative width and height of a pixel.

cleanApertureWidthN, cleanApertureWidthD: a fractional number which defines the width of the clean aperture image.

cleanApertureHeightN, cleanApertureHeightD: a fractional number which defines the height of the clean aperture image.

horizOffN, horizOffD: a fractional number which defines the horizontal offset between the clean aperture image center and the full aperture image center. Typically 0.

vertOffN, vertOffD: a fractional number which defines the vertical offset between clean aperture image center and the full aperture image center. Typically 0.

Color information may be supplied in one or more ColorInformationBoxes placed in a VisualSampleEntry. These should be placed in order in the sample entry starting with the most accurate (and potentially the most difficult to process), in progression to the least. These are advisory and concern rendering and color conversion, and there is no normative behavior associated with them; a reader may choose to use the most suitable. A ColorInformationBox with an unknown color type may be ignored.

If used, an ICC profile may be a restricted one, under the code ‘rICC’, which permits simpler processing. That profile shall be of either the monochrome or three-component matrix-based class of input profiles, as defined by ISO 15076 1. If the profile is of another class, then the ‘prof’ indicator shall be used.

If color information is supplied in both this box, and also in the video bitstream, this box takes precedence, and over-rides the information in the bitstream.

When an ICC profile is specified, SMPTE RP 177 could be of assistance if there is a need to form the Y′CbCr to R′G′B′ conversion matrix for the color primaries described by the ICC profile.

```
class ColorInformationBox extends Box(‘colr’)
  {
    unsigned int(32) color_type;
    if (color_type == ‘nclx’) /* on-screen colors */
    {
      unsigned int(16) color_primaries;
      unsigned int(16) transfer_characteristics;
      unsigned int(16) matrix_coefficients;
      unsigned int(1) full_range_flag;
      unsigned int(7) reserved = 0;
    }
    else if (color_type == ‘rICC’)
    {
      ICC_profile; // restricted ICC profile
    }
    else if (color_type == ‘prof’)
    {
      ICC_profile; // unrestricted ICC profile
    }
  }
```

color_type: an indication of the type of color information supplied.

color_primaries carries a ColorPrimaries value as defined in ISO/IEC 23091-2.

transfer_characteristics carries a TransferCharacteristics value as defined in ISO/IEC 23091-2.

matrix_coefficients carries a MatrixCoefficients value as defined in ISO/IEC 23091-2.

full_range_flag carries a VideoFullRangeFlag as defined in ISO/IEC 23091-2.

ICC_profile: an ICC profile as defined in ISO 15076 1 or ICC.1 is supplied.

Content light level box may be used to provide information about the light level in the content and may be present in a VisualSampleEntry. It is functionally equivalent to, and should be as described in, the content light level information SEI message in ITU-T H.265|ISO/IEC 23008-2, with the addition that the provisions of CTA-861-G, in which zero in some cases codes an unknown value, may be used.

```
class ContentLightLevelBox extends Box(‘clli’)
  {
    unsigned int(16) max_content_light_level;
    unsigned int(16) max_pic_average_light_level;
  }
```

Mastering display color volume box may be used to provide information about the color primaries, white point, and mastering luminance in the content and may be present in a VisualSampleEntry. It is functionally equivalent to, and shall be as described in, the mastering display color volume SEI message in ITU-T H.265|ISO/IEC 23008-2, with the addition that the provisions of CTA-861-G[35] in which zero in some cases codes an unknown value may be used.

```
  class MasteringDisplayColorVolumeBox extends Box(‘mdcv’)
{
    for (c = 0; c<3; c++) {
      unsigned int(16) display_primaries_x;
      unsigned int(16) display_primaries_y;
    }
    unsigned int(16) white_point_x;
    unsigned int(16) white_point_y;
    unsigned int(32) max_display_mastering_luminance;
    unsigned int(32) min_display_mastering_luminance;
}
```

Content color volume box describes the color volume characteristics of the associated pictures. These color volume characteristics are expressed in terms of a nominal range, although deviations from this range may occur. It is functionally equivalent to, and shall be as described in, the content color volume SEI message in Rec. ITU-T H.265|ISO/IEC 23008-2 except that the box, in a sample entry, applies to the associated content and hence the initial two bits (corresponding to the ccv_cancel_flag and ccv_persistence_flag) take the value 0.

```
class ContentColorVolumeBox extends Box(‘cclv’)
  {
    unsigned int(1) reserved = 0; // ccv_cancel_flag
    unsigned int(1) reserved = 0; // ccv_persistence_flag
    unsigned int(1) ccv_primaries_present_flag;
    unsigned int(1) ccv_min_luminance_value present_flag;
    unsigned int(1) ccv_max_luminance_value_present_flag;
    unsigned int(1) ccv_avg_luminance_value_present_flag;
    unsigned int(2) reserved = 0;
    if( ccv_primaries_present_flag ) {
      for( c = 0; c < 3; c++ ) {
        signed int(32) ccv_primaries_x[ c ];
        signed int(32) ccv_primaries_y[ c ];
      }
    }
    if( ccv_min_luminance_value_present_flag )
      unsigned int(32) ccv_min_luminance_value;
    if( ccv_max_luminance_value_present_flag )
      unsigned int(32) ccv_max_luminance_value;
    if( ccv_avg_luminance_value_present_flag )
      unsigned int(32) ccv_avg_luminance_value;
  }
```

Ambient viewing environment box may be used to provide information about the characteristics of the nominal ambient viewing environment for the display of the associated video content and may be present in a VisualSampleEntry. The syntax elements of the ambient viewing environment box may assist the receiving system in adapting the received video content for local display in viewing environments that may be similar or may substantially differ from those assumed or intended when mastering the video content. It is functionally equivalent to, and should be as described in, the ambient viewing environment SEI message in ITU-T H.265, ISO/IEC 23008-2.

```
class AmbientViewingEnvironmentBox extends Box(‘amve’)
  {
    unsigned int(32) ambient_illuminance;
    unsigned int(16) ambient_light_x;
    unsigned int(16) ambient_light_y;
  }
```

Files conforming to the ISOBMFF may contain any non-timed objects, referred to as items, meta items, or metadata items, in a meta box (four-character code: ‘meta’). While the name of the meta box refers to metadata, items can generally contain metadata or media data. The meta box may reside at the top level of the file, within a movie box (four-character code: ‘moov’), and within a track box (four-character code: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. If the metadata is located external to the file then its location may be declared by the DataInformationBox (four-character code: ‘dinf’). In the specific case that the metadata is formatted using eXtensible Markup Language (XML) syntax and is required to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored fragmented into extents, e.g., to enable interleaving. An extent is a contiguous subset of the bytes of the resource. The resource can be formed by concatenating the extents.

Split-layers and split-samples have been proposed to the ISOBMFF. Samples of a track can be split into several split-layers, a base split-layer and one or more additional split-layers, to allow storing the data of media samples as non-contiguous pieces of data in a track. A split-layer is a part of sample data of a track. A split-layer may, for example, contain one or more complete scalability layers. A base split-layer may be defined as a split-layer corresponding to the part of sample data whose offsets/sizes and timing are described by boxes in SampleTableBox or TrackFragmentBox (e.g., sample size, chunk offset, sample to chunk, time to sample). An additional split-layer may be defined as a split-layer whose offsets/sizes are described within new box(es), such as a SplitLayerBox in the SampleTableBox or TrackFragmentBox. A SplitLayerBox indicates the locations and sizes of the split-samples of an additional split-layer of the track (when contained in SampleTableBox) or the track fragment (when contained in the TrackFragmentBox). An original media sample can be obtained by reaggregating the data of the split-layers, for example by following the reconstruction process described by a new box, which may be called SplitSamplesConfigurationBox.

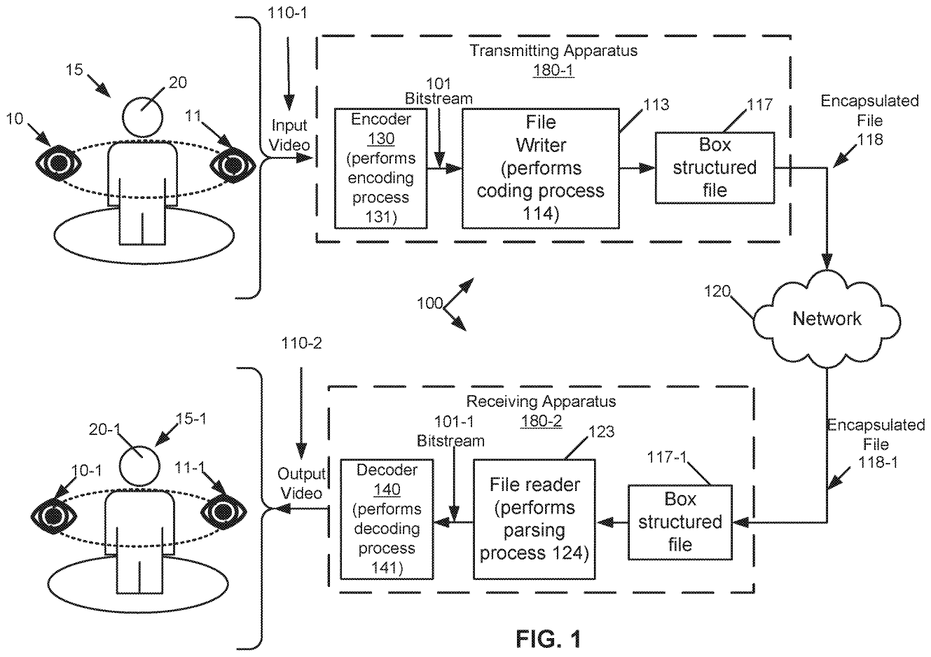

One item for description is background on video coding. Referring to FIG. 1, this figure is a block diagram illustrating a system 100 in accordance with an example. In the example, the encoder 130 is used to encode input video 110-1 from the scene 15, and the encoder 130 is implemented in a transmitting apparatus 180-1. There is a capture of input video at a viewpoint 10 of a scene 15, which includes a human being 20. The encoder 130 produces a multilayer bitstream 101, using the encoding process 131 on the input video 110-1. The file writer 113 acts to perform a coding process 114 on the multilayer bitstream 101 to write the information into and store a box structured file 117, which is an encoded file and forms at least part of encapsulated file 118 that is communicated over the network 120. The encapsulated file 118 is a version of a video bitstream that is encapsulated and contains a box structured file 117 such as an ISOBMFF structured file.

The box structured file 117 is sent (as at least part of encapsulated file 118) over the network 120, which may be a wireless channel, and the encapsulated file 118-1 (and its incorporated box structured file 117-1) is received by the receiving apparatus 180-2. This could be performed by storing a complete file as the box structured file 117, and the receiving apparatus 180-2 receive the complete file. Alternatively, parts of the box structured file 117 could be sent over time, e.g., a 2 hour movie being sent in increments of seconds, e.g., in streaming, as the encapsulated file 118. The input video 110-1 could also be real-time video, and the box structured file 117 would store only a limited amount of information for a certain time period, e.g., seconds to minutes, and would be continually updated and transmitted as encapsulated file 118.

The receiving apparatus 180-2 receives a box structured file 117-1, which has passed through the network 120. If the network is lossy, the box structured file 117-1 may be different from the box structured file 117. There is a file reader 123, which parses the information in the box structured file 117-1, and performs a parsing process 124 on the box structured file 117-1 to extract the bitstream 101-1. Is it assumed there may be differences between the bitstream 101-1 at the receiving apparatus 180-2 and the bitstream 101 at the transmitting apparatus 180-1. The receiving apparatus implements a decoder 140, which performs a decoding process 141. The decoder 140, using the decoding process 141 on the bitstream 101, forms the output video 110-2 (as a representation of the input video 110-1) for the scene 15-1, and the receiving apparatus 180-2 would present this to the user, e.g., via a smartphone, television, or projector among many other options. The scene 15-1 has a viewpoint 10-1 and contains representations of at least a human being 20-1. Another possibility is to have a “stereo representation,” which uses both a left viewpoint 10 and a right viewpoint 11 on the transmitting side (scene 15) to capture video that is encoded into the multilayer bitstream 101, and a left viewpoint 10-1 and a right viewpoint 11-1 on the receiving side (scene 15-1) for decoded video. The term viewpoint may also be referred to as a view. The encoder 130 and decoder 140 may be applied to multiple coding standards.

A video codec includes an encoder 130 and a decoder 140. The encoder 130 transforms the input video into a compressed representation suited for storage/transmission. The decoder 140 can decompress the compressed video representation back into a viewable form. A video encoder and/or a video decoder may also be separate from each other, i.e., need not form a codec, which is illustrated by the simple diagram in FIG. 1, where the encoder 130 is part of a transmitting apparatus 180-1 and the decoder 140 is part of a receiving apparatus 180-2. Both sides could have encoders, but FIG. 1 is presented for ease of description. The encoder 130 may discard some information in the original video sequence in order to represent the video in a more compact form (that is, at lower bitrate).

Hybrid video encoders 130, for example many encoder implementations of ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team—Video Coding (JCT-VC) of VCEG and MPEG (Moving picture experts' group). The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC (Scalable High Efficiency Video Coding), MV-HEVC (Multiview High Efficiency Video Coding), 3D-HEVC (three-dimensional High Efficiency Video Coding), and REXT (HEVC format range extension), respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the priority date of this document, unless otherwise indicated.

SHVC, MV-HEVC, and 3D-HEVC use a common basis specification, specified in Annex F of the version 2 of the HEVC standard. This common basis comprises for example high-level syntax and semantics, e.g., specifying some of the characteristics of the layers of the bitstream, such as inter-layer dependencies, as well as decoding processes, such as reference picture list construction including inter-layer reference pictures and picture order count derivation for multilayer bitstream. Annex F may also be used in potential subsequent multilayer extensions of HEVC. It is to be understood that even though a video encoder 130, a video decoder 140, encoding methods, decoding methods, bitstream structures, and/or embodiments may be described in the following with reference to specific extensions, such as SHVC and/or MV-HEVC, they are generally applicable to any multilayer extensions of HEVC, and even more generally to any multilayer video coding scheme.

The Versatile Video Coding standard (which may be abbreviated VVC, H.266, or H.266/VVC) was developed by the Joint Video Experts Team (JVET), which is a collaboration between the ISO/IEC MPEG and ITU-T VCEG. Extensions to VVC are presently under development.

A specification of the AV1 bitstream format and decoding process were developed by the Alliance of Open Media (AOM). The AV1 specification was published in 2018. AOM is reportedly working on the AV2 specification.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in HEVC—hence, they are described below jointly. The aspects herein are not limited to H.264/AVC or HEVC, but rather the description is given for one possible basis on top of which the examples may be partly or fully realized. Many aspects described below in the context of H.264/AVC or HEVC may apply to VVC, and the aspects of the examples may hence be applied to VVC.

Similarly to many earlier video coding standards, the bitstream syntax and semantics as well as the decoding process for error-free bitstreams are specified in H.264/AVC and HEVC. The encoding process is not specified, but encoders should generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. A picture given as an input to an encoder may also be referred to as a source picture, and a picture decoded by a decoded may be referred to as a decoded picture.

The source and decoded pictures are each comprised of one or more sample arrays, such as one of the following sets of sample arrays: 1) Luma (Y) only (monochrome); 2) Luma and two chroma (YCbCr or YCgCo); 3) Green, Blue and Red (GBR, also known as RGB); 4) Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr; regardless of the actual color representation method in use. The actual color representation method in use can be indicated, e.g., in a coded bitstream, e.g., using the Video Usability Information (VUI) syntax of H.264/AVC and/or HEVC. A component may be defined as an array or single sample from one of the three sample arrays (luma and two chroma) or the array or a single sample of the array that compose a picture in monochrome format.

In H.264/AVC and HEVC, a picture may either be a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays. Chroma formats may be summarized as follows: 1) In monochrome sampling there is only one sample array, which may be nominally considered the luma array; 2) In 4:2:0 sampling, each of the two chroma arrays has half the height and half the width of the luma array; 3) In 4:2:2 sampling, each of the two chroma arrays has the same height and half the width of the luma array; 4) In 4:4:4 sampling when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

A partitioning may be defined as a division of a set into subsets such that each element of the set is in exactly one of the subsets.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples. A CU with the maximum allowed size may be named as LCU (largest coding unit) or coding tree unit (CTU) and the video picture is divided into non-overlapping LCUs.

A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g., motion vector information for inter predicted PUs and intra prediction directionality information for intra predicted PUs).

Each TU can be associated with information describing the prediction error decoding process for the samples within the TU (including, e.g., DCT coefficient information). It may be signaled at CU level whether prediction error coding is applied or not for each CU. In the case there is no prediction error residual associated with the CU, it can be considered there are no TUs for the CU. The division of the image into CUs, and division of CUs into PUs and TUs may be signaled in the bitstream allowing the decoder to reproduce the intended structure of these units.

In HEVC, a picture can be partitioned in tiles, which are rectangular and contain an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture if tiles are not in use. Within an LCU, the CUs have a specific scan order.

An intra-coded slice (also called I slice) is such that it only contains intra-coded blocks. The syntax of an I slice may exclude syntax elements that are related to inter prediction. An inter-coded slice is such where blocks can be intra- or inter-coded. Inter-coded slices may further be categorized into P and B slices, where P slices are such that blocks may be intra-coded or inter-coded but only using uni-prediction, and blocks in B slices may be intra-coded or inter-coded with uni- or bi-prediction.

The decoder reconstructs the output video by applying prediction similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF). H.264/AVC includes a deblocking, whereas HEVC includes both deblocking and SAO (Sample adaptive offset).

In video codecs, the motion information may be indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently, those are typically coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, it can be predicted which reference picture(s) are used for motion-compensated prediction and this prediction information may be represented for example by a reference index of previously coded/decoded picture. The reference index is typically predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R , \qquad ( 1 )$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring CU may be regarded as unavailable for intra prediction, if the neighboring CU resides in a different slice.

An elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit (NALU) may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0 (zero).

NAL units include a header and payload. In H.264/AVC and HEVC, the NAL unit header indicates the type of the NAL unit. In HEVC, a two-byte NAL unit header is used for all specified NAL unit types. The NAL unit header contains one reserved bit, a six-bit NAL unit type indication, a three-bit nuh_temporal_id_plus1 indication for temporal level (may be required to be greater than or equal to 1) and a six-bit nuh_layer_id syntax element. The temporal_id_plus1 syntax element may be regarded as a temporal identifier for the NAL unit, and a zero-based TemporalId variable may be derived as follows: TemporalId=temporal_id_plus1−1. The abbreviation TID may be used to interchangeably with the TemporalId variable. TemporalId equal to 0 (zero) corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to tid_value does not use any picture having a TemporalId greater than tid_value as inter prediction reference. A sub-layer or a temporal sub-layer may be defined to be a temporal scalable layer (or a temporal layer, TL) of a temporal scalable bitstream, consisting of VCL NAL units with a particular value of the TemporalId variable and the associated non-VCL NAL units. nuh_layer_id can be understood as a scalability layer identifier.

NAL units can be categorized into Video Coding Layer (VCL) NAL units and non-VCL NAL units. VCL NAL units may be coded slice NAL units. In HEVC, VCL NAL units contain syntax elements representing one or more CUs.

In HEVC, abbreviations for picture types may be defined as follows: trailing (TRAIL) picture, Temporal Sub-layer Access (TSA), Step-wise Temporal Sub-layer Access (STSA), Random Access Decodable Leading (RADL) picture, Random Access Skipped Leading (RASL) picture, Broken Link Access (BLA) picture, Instantaneous Decoding Refresh (IDR) picture, Clean Random Access (CRA) picture.

A Random-Access Point (RAP) picture, which may also be referred to as an intra random access point (IRAP) picture in an independent layer contains only intra-coded slices. An IRAP picture belonging to a predicted layer may contain P, B, and I slices, cannot use inter prediction from other pictures in the same predicted layer, and may use inter-layer prediction from its direct reference layers. In the present version of HEVC, an IRAP picture may be a BLA picture, a CRA picture or an IDR picture. The first picture in a bitstream containing a base layer is an IRAP picture at the base layer. Provided the necessary parameter sets are available when they need to be activated, an IRAP picture at an independent layer and all subsequent non-RASL pictures at the independent layer in decoding order can be correctly decoded without performing the decoding process of any pictures that precede the IRAP picture in decoding order. The IRAP picture belonging to a predicted layer and all subsequent non-RASL pictures in decoding order within the same predicted layer can be correctly decoded without performing the decoding process of any pictures of the same predicted layer that precede the IRAP picture in decoding order, when the necessary parameter sets are available when they need to be activated and when the decoding of each direct reference layer of the predicted layer has been initialized. There may be pictures in a bitstream that contain only intra-coded slices that are not IRAP pictures.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. In HEVC a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In HEVC, a video parameter set (VPS) may be defined as a syntax structure containing syntax elements that apply to zero or more entire coded video sequences as determined by the content of a syntax element found in the SPS (sequence parameter set) referred to by a syntax element found in the PPS (Picture parameter set) referred to by a syntax element found in each slice segment header.

A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

The VPS may provide information about the dependency relationships of the layers in a bitstream, as well as many other information that are applicable to all slices across all (scalability or view) layers in the entire coded video sequence. The VPS may be considered to comprise two parts, the base VPS and a VPS extension, where the VPS extension may be optionally present.

Out-of-band transmission, signaling, or storage can additionally or alternatively be used for other purposes than tolerance against transmission errors, such as ease of access or session negotiation. For example, a sample entry of a track in a file conforming to the ISO Base Media File Format may comprise parameter sets, while the coded data in the bitstream is stored elsewhere in the file or in another file. The phrase along the bitstream (e.g., indicating along the bitstream) may be used in claims and described embodiments to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream.

An SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

In HEVC, there are two types of SEI NAL units, namely the suffix SEI NAL unit and the prefix SEI NAL unit, having a different nal_unit_type value from each other. The SEI message(s) contained in a suffix SEI NAL unit are associated with the VCL NAL unit preceding, in decoding order, the suffix SEI NAL unit. The SEI message(s) contained in a prefix SEI NAL unit are associated with the VCL NAL unit following, in decoding order, the prefix SEI NAL unit.

A coded picture is a coded representation of a picture. In more detail, in HEVC, a coded picture may be defined as a coded representation of a picture containing all coding tree units of the picture. In HEVC, an access unit (AU) may be defined as a set of NAL units that are associated with each other according to a specified classification rule, are consecutive in decoding order, and contain at most one picture with any specific value of nuh_layer_id. In addition to containing the VCL NAL units of the coded picture, an access unit may also contain non-VCL NAL units. Said specified classification rule may for example associate pictures with the same output time or picture output count value into the same access unit.

A bitstream may be defined as a sequence of bits, in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. The end of the first bitstream may be indicated by a specific NAL unit, which may be referred to as the end of bitstream (EOB) NAL unit and which is the last NAL unit of the bitstream. In HEVC and its current draft extensions, the EOB NAL unit is required to have nuh_layer_id equal to 0 (zero).

A coded video sequence may be defined as such a sequence of coded pictures in decoding order that is independently decodable and is followed by another coded video sequence or the end of the bitstream or an end of sequence NAL unit.

In HEVC, a coded video sequence may additionally or alternatively (to the specification above) be specified to end, when a specific NAL unit, which may be referred to as an end of sequence (EOS) NAL unit, appears in the bitstream and has nuh_layer_id equal to 0.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An HEVC decoder can recognize an intra picture starting an open GOP, because a specific NAL unit type, CRA NAL unit type, may be used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP may start from an IDR picture. In HEVC a closed GOP may also start from a BLA_W_RADL or a BLA_N_LP picture. An open GOP coding structure is potentially more efficient in the compression compared to a closed GOP coding structure, due to a larger flexibility in selection of reference pictures.

A Structure of Pictures (SOP) may be defined as one or more coded pictures consecutive in decoding order, in which the first coded picture in decoding order is a reference picture at the lowest temporal sub-layer and no coded picture except potentially the first coded picture in decoding order is a RAP picture. All pictures in the previous SOP precede in decoding order all pictures in the current SOP and all pictures in the next SOP succeed in decoding order all pictures in the current SOP. A SOP may represent a hierarchical and repetitive inter prediction structure. The term group of pictures (GOP) may sometimes be used interchangeably with the term SOP and may have the same semantics as the semantics of SOP.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice.

A reference picture list, such as the reference picture list 0 and the reference picture list 1, may be constructed in two steps: First, an initial reference picture list is generated. The initial reference picture list may be generated for example on the basis of frame_num, POC, temporal_id, or information on the prediction hierarchy such as a GOP structure, or any combination thereof. Second, the initial reference picture list may be reordered by reference picture list reordering (RPLR) syntax, also known as reference picture list modification syntax structure, which may be contained in slice headers. The initial reference picture lists may be modified through the reference picture list modification syntax structure, where pictures in the initial reference picture lists may be identified through an entry index to the list.

Many coding standards, including H.264/AVC and HEVC, may have decoding process to derive a reference picture index to a reference picture list, which may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Several candidate motion vectors may be derived for a single prediction unit. For example, motion vector prediction HEVC includes two motion vector prediction schemes, namely the advanced motion vector prediction (AMVP) and the merge mode. In the AMVP or the merge mode, a list of motion vector candidates is derived for a PU. There are two kinds of candidates: spatial candidates and temporal candidates, where temporal candidates may also be referred to as TMVP (Temporal motion vector predictor) candidates.

A candidate list derivation may be performed for example as follows, while it should be understood that other possibilities may exist for candidate list derivation. If the occupancy of the candidate list is not at maximum, the spatial candidates are included in the candidate list first if they are available and not already exist in the candidate list. After that, if occupancy of the candidate list is not yet at maximum, a temporal candidate is included in the candidate list. If the number of candidates still does not reach the maximum allowed number, the combined bi-predictive candidates (for B slices) and a zero motion vector are added in. After the candidate list has been constructed, the encoder decides the final motion information from candidates for example based on a rate-distortion optimization (RDO) decision and encodes the index of the selected candidate into the bitstream. Likewise, the decoder decodes the index of the selected candidate from the bitstream, constructs the candidate list, and uses the decoded index to select a motion vector predictor from the candidate list.

A motion vector anchor position may be defined as a position (e.g., horizontal and vertical coordinates) within a picture area relative to which the motion vector is applied. A horizontal offset and a vertical offset for the anchor position may be given in the slice header, slice parameter set, tile header, tile parameter set, or the like.

An example encoding method taking advantage of a motion vector anchor position comprises: encoding an input picture into a coded constituent picture; reconstructing, as a part of said encoding, a decoded constituent picture corresponding to the coded constituent picture; encoding a spatial region into a coded tile, the encoding comprising: determining a horizontal offset and a vertical offset indicative of a region-wise anchor position of the spatial region within the decoded constituent picture; encoding the horizontal offset and the vertical offset; determining that a prediction unit at position of a first horizontal coordinate and a first vertical coordinate of the coded tile is predicted relative to the region-wise anchor position, wherein the first horizontal coordinate and the first vertical coordinate are horizontal and vertical coordinates, respectively, within the spatial region; indicating that the prediction unit is predicted relative to a prediction-unit anchor position that is relative to the region-wise anchor position; deriving a prediction-unit anchor position equal to sum of the first horizontal coordinate and the horizontal offset, and the first vertical coordinate and the vertical offset, respectively; determining a motion vector for the prediction unit; and applying the motion vector relative to the prediction-unit anchor position to obtain a prediction block.

An example decoding method wherein a motion vector anchor position is used comprises: decoding a coded tile into a decoded tile, the decoding comprising: decoding a horizontal offset and a vertical offset; decoding an indication that a prediction unit at position of a first horizontal coordinate and a first vertical coordinate of the coded tile is predicted relative to a prediction-unit anchor position that is relative to the horizontal and vertical offset; deriving a prediction-unit anchor position equal to sum of the first horizontal coordinate and the horizontal offset, and the first vertical coordinate and the vertical offset, respectively; determining a motion vector for the prediction unit; and applying the motion vector relative to the prediction-unit anchor position to obtain a prediction block.

Scalable video coding may refer to coding structure where one bitstream can contain multiple representations of the content, for example, at different bitrates, resolutions or frame rates. In these cases the receiver can extract the desired representation depending on its characteristics (e.g., resolution that matches best the display device). Alternatively, a server or a network element can extract the portions of the bitstream to be transmitted to the receiver depending on, e.g., the network characteristics or processing capabilities of the receiver. A meaningful decoded representation can be produced by decoding only certain parts of a scalable bit stream. A scalable bitstream may consist of a “base layer” providing the lowest quality video available and one or more enhancement layers that enhance the video quality when received and decoded together with the lower layers. In order to improve coding efficiency for the enhancement layers, the coded representation of that layer typically depends on the lower layers, e.g., the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance, for example, the temporal resolution (i.e., the frame rate), the spatial resolution, or simply the quality of the video content represented by another layer or part thereof. Each layer together with all its dependent layers is one representation of the video signal, for example, at a certain spatial resolution, temporal resolution and quality level. In this document, a scalable layer together with all of its dependent layers is referred to as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following.

1) Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.

2) Spatial scalability: Base layer pictures are coded at a lower resolution (i.e., have fewer samples) than enhancement layer pictures. Spatial scalability and quality scalability, particularly its coarse-grain scalability type, may sometimes be considered the same type of scalability.

3) View scalability, which may also be referred to as multiview coding. The base layer represents a first view, whereas an enhancement layer represents a second view. A view may be defined as a sequence of pictures representing one camera or viewpoint. It may be considered that in stereoscopic or two-view video, one video sequence or view is presented for the left eye while a parallel view is presented for the right eye.

4) Depth scalability, which may also be referred to as depth-enhanced coding. A layer or some layers of a bitstream may represent texture view(s), while other layer or layers may represent depth view(s).

It should be understood that many of the scalability types may be combined and applied together.

The term “layer” may be used in context of any type of scalability, including view scalability and depth enhancements. An enhancement layer may refer to any type of an enhancement, such as SNR, spatial, multiview, and/or depth enhancement. A base layer may refer to any type of a base video sequence, such as a base view, a base layer for SNR/spatial scalability, or a texture base view for depth-enhanced video coding.

A sender, a gateway, a client, or another entity as the transmitting apparatus 180-1 may select the transmitted layers and/or sub-layers of a scalable video bitstream. The terms layer extraction, extraction of layers, or layer down-switching may refer to transmitting fewer layers than what is available in the bitstream 101 received by the sender (here, it is assumed the sender receives the bitstream from the origin), the gateway, the client, or another entity acting as receiving apparatus 180-2. Layer up-switching may refer to transmitting additional layer(s) compared to those transmitted prior to the layer up-switching by the sender, the gateway, the client, or another entity, i.e., restarting the transmission of one or more layers whose transmission was ceased earlier in layer down-switching. Similarly to layer down-switching and/or up-switching, the sender, the gateway, the client, or another entity may perform down- and/or up-switching of temporal sub-layers. The sender, the gateway, the client, or another entity may also perform both layer and sub-layer down-switching and/or up-switching. Layer and sub-layer down-switching and/or up-switching may be conducted in the same access unit or alike (i.e., virtually simultaneously) or may be carried out in different access units or alike (i.e., virtually at distinct times).

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the DPB. An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, if any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g., sample values or motion vectors) of reference pictures from a different layer than the layer of the current picture (being encoded or decoded). Many types of inter-layer prediction exist and may be applied in a scalable video encoder/decoder. The available types of inter-layer prediction may for example depend on the coding profile according to which the bitstream or a particular layer within the bitstream is being encoded or, when decoding, the coding profile that the bitstream or a particular layer within the bitstream is indicated to conform to. Alternatively or additionally, the available types of inter-layer prediction may depend on the types of scalability or the type of a scalable codec or video coding standard amendment (e.g., SHVC, MV-HEVC, or 3D-HEVC) being used.

A direct reference layer may be defined as a layer that may be used for inter-layer prediction of another layer for which the layer is the direct reference layer. A direct predicted layer may be defined as a layer for which another layer is a direct reference layer. An indirect reference layer may be defined as a layer that is not a direct reference layer of a second layer but is a direct reference layer of a third layer that is a direct reference layer or indirect reference layer of a direct reference layer of the second layer for which the layer is the indirect reference layer. An indirect predicted layer may be defined as a layer for which another layer is an indirect reference layer. An independent layer may be defined as a layer that does not have direct reference layers. In other words, an independent layer is not predicted using inter-layer prediction. A non-base layer may be defined as any other layer than the base layer, and the base layer may be defined as the lowest layer in the bitstream. An independent non-base layer may be defined as a layer that is both an independent layer and a non-base layer.

Similarly to MVC, in MV-HEVC, inter-view reference pictures can be included in the reference picture list(s) of the current picture being coded or decoded. SHVC uses multi-loop decoding operation (unlike the SVC extension of H.264/AVC). SHVC may be considered to use a reference index-based approach, i.e., an inter-layer reference picture can be included in a one or more reference picture lists of the current picture being coded or decoded (as described above).

For the enhancement layer coding, the concepts and coding tools of HEVC base layer may be used in SHVC, MV-HEVC, and/or alike. However, the additional inter-layer prediction tools, which employ already coded data (including reconstructed picture samples and motion parameters a.k.a motion information) in reference layer for efficiently coding an enhancement layer, may be integrated to SHVC, MV-HEVC, and/or alike codec.

Video coding specifications may contain a set of constraints for associating data units (e.g., NAL units in H.264/AVC or HEVC) into access units. These constraints may be used to conclude access unit boundaries from a sequence of NAL units. For example, the following is specified in the HEVC standard:

1) An access unit consists of one coded picture with nuh_layer_id equal to 0, zero or more VCL NAL units with nuh_layer_id greater than 0 and zero or more non-VCL NAL units.

2) Let firstBlPicNalUnit be the first VCL NAL unit of a coded picture with nuh_layer_id equal to 0. The first of any of the following NAL units preceding firstBlPicNalUnit and succeeding the last VCL NAL unit preceding firstBlPicNalUnit, if any, specifies the start of a new access unit: a) access unit delimiter NAL unit with nuh_layer_id equal to 0 (when present), b) VPS NAL unit with nuh_layer_id equal to 0 (when present), c) SPS NAL unit with nuh_layer_id equal to 0 (when present), d) PPS NAL unit with nuh_layer_id equal to 0 (when present), e) Prefix SEI NAL unit with nuh_layer_id equal to 0 (when present), f) NAL units with nal_unit_type in the range of RSV_NVCL41 . . . RSV_NVCL44 with nuh_layer_id equal to 0 (when present), g) NAL units with nal_unit_type in the range of UNSPEC48 . . . UNSPEC55 with nuh_layer_id equal to 0 (when present).

The first NAL unit preceding firstBlPicNalUnit and succeeding the last VCL NAL unit preceding firstBlPicNalUnit, if any, can only be one of the above-listed NAL units.

When there are none of the above NAL units preceding firstBlPicNalUnit and succeeding the last VCL NAL preceding firstBlPicNalUnit, if any, firstBlPicNalUnit starts a new access unit.

Access unit boundary detection may be based on but may not be limited to one or more of the following.

1) Detecting that a VCL NAL unit of a base-layer picture is the first VCL NAL unit of an access unit, e.g., on the basis that: a) the VCL NAL unit includes a block address or alike that is the first block of the picture in decoding order; and/or b) the picture order count, picture number, or similar decoding or output order or timing indicator differs from that of the previous VCL NAL unit(s).

2) Having detected the first VCL NAL unit of an access unit, concluding based on pre-defined rules, e.g., based on nal_unit_type which non-VCL NAL units that precede the first VCL NAL unit of an access unit and succeed the last VCL NAL unit of the previous access unit in decoding order belong to the access unit.

The Versatile Video Coding (VVC) includes new coding tools compared to HEVC or H.264/AVC. These coding tools are related to, for example, intra prediction; inter-picture prediction; transform, quantization and coefficients coding; entropy coding; in-loop filter; screen content coding; 360-degree video coding; high-level syntax and parallel processing. Some of these tools are briefly described in the following.

1) Intra prediction: a) 67 intra mode with wide angles mode extension; b) Block size and mode dependent 4 tap interpolation filter; c) Position dependent intra prediction combination (PDPC); d) Cross component linear model intra prediction (CCLM); e) Multi-reference line intra prediction; f) Intra sub-partitions; g) Weighted intra prediction with matrix multiplication.

2) Inter-picture prediction: a) Block motion copy with spatial, temporal, history-based, and pairwise average merging candidates; b) Affine motion inter prediction; c) sub-block based temporal motion vector prediction; d) Adaptive motion vector resolution; e) 8×8 block-based motion compression for temporal motion prediction; f) High precision ( 1/16 pel) motion vector storage and motion compensation with 8-tap interpolation filter for luma component and 4-tap interpolation filter for chroma component; g) Triangular partitions; h) Combined intra and inter prediction; i) Merge with motion vector difference (MVD) (MMVD); j) Symmetrical MVD (motion vector difference) coding; k) Bi-directional optical flow; 1) Decoder side motion vector refinement; m) Bi-prediction with CU-level weight.

3) Transform, quantization and coefficients coding: a) Multiple primary transform selection with DCT2, DST7 and DCT8; b) Secondary transform for low frequency zone; c) Sub-block transform for inter predicted residual; d) Dependent quantization with max QP (quantization parameter) increased from 51 to 63; e) Transform coefficient coding with sign data hiding; f) Transform skip residual coding.

4) Entropy Coding: a) Arithmetic coding engine with adaptive double windows probability update

5) In loop filter: a) In-loop reshaping; b) Deblocking filter with strong longer filter; c) Sample adaptive offset; d) Adaptive Loop Filter.

6) Screen content coding: a) Current picture referencing with reference region restriction

7) 360-degree video coding: a) Horizontal wrap-around motion compensation

8) High-level syntax and parallel processing: a) Reference picture management with direct reference picture list signaling; b) Tile groups with rectangular shape tile groups.

In VVC, each picture may be partitioned into coding tree units (CTUs) similar to HEVC. A CTU may be split into smaller CUs using quaternary tree structure. Each CU may be partitioned using quad-tree and nested multi-type tree including ternary and binary split. There are specific rules to infer partitioning in picture boundaries. The redundant split patterns are disallowed in nested multi-type partitioning.

In some video coding schemes, such as HEVC and VVC, a picture is divided into one or more tile rows and one or more tile columns. The partitioning of a picture to tiles forms a tile grid that may be characterized by a list of tile column widths and a list of tile row heights. A tile may be required to contain an integer number of elementary coding blocks, such as CTUs in HEVC and VVC. Consequently, tile column widths and tile row heights may be expressed in the units of elementary coding blocks, such as CTUs in HEVC and VVC.

A tile may be defined as a sequence of elementary coding blocks, such as CTUs in HEVC and VVC, that covers one “cell” in the tile grid, i.e., a rectangular region of a picture. Elementary coding blocks, such as CTUs, may be ordered in the bitstream in raster scan order within a tile.

Some video coding schemes may allow further subdivision of a tile into one or more bricks, each of which consisting of a number of CTU rows within the tile. A tile that is not partitioned into multiple bricks may also be referred to as a brick. However, a brick that is a true subset of a tile is not referred to as a tile.

In some video coding schemes, such as H.264/AVC, HEVC and VVC, a coded picture may be partitioned into one or more slices. A slice may be decodable independently of other slices of a picture and hence a slice may be considered as a preferred unit for transmission. In some video coding schemes, such as H.264/AVC, HEVC, and VVC, a video coding layer (VCL) NAL unit contains exactly one slice.

A slice may comprise an integer number of elementary coding blocks, such as CTUs in HEVC or VVC. In some video coding schemes, such as VVC, a slice contains an integer number of tiles of a picture or an integer number of CTU rows of a tile. In some video coding schemes, two modes of slices may be supported, namely the raster-scan slice mode and the rectangular slice mode. In the raster-scan slice mode, a slice contains a sequence of tiles in a tile raster scan of a picture. In the rectangular slice mode, a slice contains an integer number of tiles of a picture or an integer number of CTU rows of a tile that collectively form a rectangular region of the picture.

A non-VCL NAL unit may be for example one of the following types: a video parameter set (VPS), a sequence parameter set (SPS), a picture parameter set (PPS), an adaptation parameter set (APS), a supplemental enhancement information (SEI) NAL unit, a picture header (PH) NAL unit, an end of sequence NAL unit, an end of bitstream NAL unit, or a filler data NAL unit. Some non-VCL NAL units, such as parameter sets and picture headers, may be needed for the reconstruction of decoded pictures, whereas many of the other non-VCL NAL units might not be necessary for the reconstruction of decoded sample values.

Some coding formats specify parameter sets that may carry parameter values needed for the decoding or reconstruction of decoded pictures. Some examples of different types of parameter sets are briefly described in this paragraph. A video parameter set (VPS) may include parameters that are common across multiple layers in a coded video sequence or describe relations between layers. Parameters that remain unchanged through a coded video sequence (in a single-layer bitstream) or in a coded layer video sequence may be included in a sequence parameter set (SPS). In addition to the parameters that may be needed by the decoding process, the sequence parameter set may optionally contain video usability information (VUI), which includes parameters that may be important for buffering, picture output timing, rendering, and resource reservation. A picture parameter set (PPS) contains such parameters that are likely to be unchanged in several coded pictures. A picture parameter set may include parameters that can be referred to by the coded image segments of one or more coded pictures. A header parameter set (HPS) has been proposed to contain such parameters that may change on picture basis. In VVC, an Adaptation Parameter Set (APS) may comprise parameters for decoding processes of different types, such as adaptive loop filtering or luma mapping with chroma scaling.

A parameter set may be activated when it is referenced, e.g., through its identifier. For example, a header of an image segment, such as a slice header, may contain an identifier of the PPS that is activated for decoding the coded picture containing the image segment. A PPS may contain an identifier of the SPS that is activated, when the PPS is activated. An activation of a parameter set of a particular type may cause the deactivation of the previously active parameter set of the same type.

Instead of or in addition to parameter sets at different hierarchy levels (e.g., sequence and picture), video coding formats may include header syntax structures, such as a sequence header or a picture header. A sequence header may precede any other data of the coded video sequence in the bitstream order. A picture header may precede any coded video data for the picture in the bitstream order.

Video coding specifications may enable the use of supplemental enhancement information (SEI) messages or alike. Some video coding specifications include SEI NAL units, and some video coding specifications contain both prefix SEI NAL units and suffix SEI NAL units. A prefix SEI NAL unit can start a picture unit or alike; and a suffix SEI NAL unit can end a picture unit or alike. Hereafter, an SEI NAL unit may equivalently refer to a prefix SEI NAL unit or a suffix SEI NAL unit. An SEI NAL unit includes one or more SEI messages, which are not required for the decoding of output pictures but may assist in related processes, such as picture output timing, post-processing of decoded pictures, rendering, error detection, error concealment, and resource reservation.

Several SEI messages are specified in H.264/AVC, H.265/HEVC, H.266/VVC, and H.274/VSEI standards, and the user data SEI messages enable organizations and companies to specify SEI messages for specific use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture.

A bitstream 101 may be defined as a sequence of bits, which may in some coding formats or standards be in the form of a NAL unit stream or a byte stream, which forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and which is the last NAL unit of the bitstream.

A coded video sequence (CVS) may be defined as such a sequence of coded pictures in decoding order that is independently decodable and is followed by another coded video sequence or the end of the bitstream.

The subpicture feature of VVC allows for partitioning of the VVC bitstream in a flexible manner as multiple rectangles representing subpictures, where each subpicture comprises one or more slices. In other words, a subpicture may be defined as a rectangular region of one or more slices within a picture, wherein the one or more slices are complete. Consequently, a subpicture consists of one or more slices that collectively cover a rectangular region of a picture. The slices of a subpicture may be required to be rectangular slices.

In VVC, the feature of subpictures enables efficient extraction of subpicture(s) from one or more bitstream and merging the extracted subpictures to form another bitstream without excessive penalty in compression efficiency and without modifications of VCL NAL units (i.e., slices).

The use of subpictures in a coded video sequence (CVS), however, requires appropriate configuration of the encoder and other parameters such as SPS/PPS and so on. In VVC, a layout of partitioning of a picture to subpictures may be indicated in and/or decoded from an SPS. A subpicture layout may be defined as a partitioning of a picture to subpictures. In VVC, the SPS syntax indicates the partitioning of a picture to subpictures by providing for each subpicture syntax elements indicative of the x and y coordinates of the top-left corner of the subpicture, the width of the subpicture, and the height of the subpicture, in CTU units. One or more of the following properties may be indicated (e.g., by an encoder) or decoded (e.g., by a decoder) or inferred (e.g., by an encoder and/or a decoder) for the subpictures collectively or per each subpicture individually: i) whether or not a subpicture is treated like a picture in the decoding process (or equivalently, whether or not subpicture boundaries are treated like picture boundaries in the decoding process); in some cases, this property excludes in-loop filtering operations, which may be separately indicated/decoded/inferred; ii) whether or not in-loop filtering operations are performed across the subpicture boundaries. When a subpicture is treated like a picture in the decoding process, any references to sample locations outside the subpicture boundaries are saturated to be within the subpicture boundaries. This may be regarded being equivalent to padding samples outside subpicture boundaries with the boundary sample values for decoding the subpicture. Consequently, motion vectors may be allowed to cause references outside subpicture boundaries in a subpicture that is extractable.

An independent subpicture (a.k.a. an extractable subpicture) may be defined as a subpicture i) with subpicture boundaries that are treated as picture boundaries and ii) without loop filtering across the subpicture boundaries. A dependent subpicture may be defined as a subpicture that is not an independent subpicture.

In video coding, an isolated region may be defined as a picture region that is allowed to depend only on the corresponding isolated region in reference pictures and does not depend on any other picture regions in the current picture or in the reference pictures. The corresponding isolated region in reference pictures may be for example the picture region that collocates with the isolated region in a current picture. A coded isolated region may be decoded without the presence of any picture regions of the same coded picture.

A VVC subpicture with boundaries treated like picture boundaries may be regarded as an isolated region.

A motion-constrained tile set (MCTS) is a set of tiles such that the inter prediction process is constrained in encoding such that no sample value outside the MCTS, and no sample value at a fractional sample position that is derived using one or more sample values outside the motion-constrained tile set, is used for inter prediction of any sample within the motion-constrained tile set. Additionally, the encoding of an MCTS is constrained in a manner that no parameter prediction takes inputs from blocks outside the MCTS. For example, the encoding of an MCTS is constrained in a manner that motion vector candidates are not derived from blocks outside the MCTS. In HEVC, this may be enforced by turning off temporal motion vector prediction of HEVC, or by disallowing the encoder to use the temporal motion vector prediction (TMVP) candidate or any motion vector prediction candidate following the TMVP candidate in a motion vector candidate list for prediction units located directly left of the right tile boundary of the MCTS except the last one at the bottom right of the MCTS.

In general, an MCTS may be defined to be a tile set that is independent of any sample values and coded data, such as motion vectors, which are outside the MCTS. An MCTS sequence may be defined as a sequence of respective MCTSs in one or more coded video sequences or alike. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures. A motion-constrained tile set may be regarded as an independently coded tile set, since it may be decoded without the other tile sets. An MCTS is an example of an isolated region.

The VVC (Versatile Video Coding) has a functionality of subpictures which may be regarded to improve the motion constrained tiles. VVC support for real-time conversational and low latency use cases will be important to fully exploit the functionality and end user benefit with modern networks (e.g., URLLC, Ultra reliable low latency communication, 5G networks, OTT, over-the-top, delivery, or the like). VVC encoding and decoding is computationally complex. With increasing computational complexity, the end-user devices consuming the content are heterogeneous, for example, devices supporting single decoding instances to devices supporting multiple decoding instances and more sophisticated devices having multiple decoders. Consequently, the system carrying the payload should be able to support a variety of scenarios for scalable deployments. There has been rapid growth in the resolution (e.g., 8K) of the video consumed via CE (Consumer Electronics) devices (e.g., TVs, mobile devices) which can benefit with the ability to execute multiple parallel decoders. One example use case can be parallel decoding for low latency unicast or multicast delivery of 8K VVC encoded content.

The AV1 codec supports input video signals in the 4:0:0 (monochrome), 4:2:0, 4:2:2, and 4:4:4 formats. The allowed pixel representations are 8, 10, and 12 bits. The AV1 codec operates on pixel blocks. Each pixel block is processed in a predictive-transform coding scheme, where the prediction comes from either intraframe reference pixels, interframe motion compensation, or some combinations of the two. The residuals undergo a 2-D unitary transform to further remove the spatial correlations, and the transform coefficients are quantized. Both the prediction syntax elements and the quantized transform coefficient indexes are then entropy coded using arithmetic coding. There are three optional in-loop postprocessing filter stages to enhance the quality of the reconstructed frame for reference by subsequent coded frames. A normative film grain synthesis unit is also available to improve the perceptual quality of the displayed frames.

The AV1 bitstream is packetized into open bitstream units (OBUs). An ordered sequence of OBUs is fed into the AV1 decoding process, where each OBU comprises a variable length string of bytes. An OBU contains a header and a payload. The header identifies the OBU type and specifies the payload size. The OBU types may include the following.

1) Sequence Header contains information that applies to the entire sequence, e.g., sequence profile and whether to enable certain coding tools.

2) Temporal Delimiter indicates the frame presentation time stamp. All displayable frames following a temporal delimiter OBU will use this time stamp, until the next temporal delimiter OBU arrives. A temporal delimiter and its subsequent OBUs of the same time stamp are referred to as a temporal unit. In the context of scalable coding, the compression data associated with all representations of a frame at various spatial and fidelity resolutions will be in the same temporal unit.

3) Frame Header sets up the coding information for a given frame, including signaling inter or intraframe type, indicating the reference frames and signaling probability model update method.

4) Tile Group contains the tile data associated with a frame. Each tile can be independently decoded. The collective reconstructions form the reconstructed frame after potential loop filtering.

5) Frame contains the frame header and tile data. The frame OBU is largely equivalent to a frame header OBU and a tile group OBU but allows less overhead cost.

6) Metadata carries information, such as high dynamic range, scalability, and timecode.

7) Tile List contains tile data similar to a tile group OBU. However, each tile here has an additional header that indicates its reference frame index and position in the current frame. This allows the decoder to process a subset of tiles and display the corresponding part of the frame, without the need to fully decode all the tiles in the frame.

MPEG-5 Part 2 Low Complexity Enhancement Video Coding (LCEVC) is published as ISO/IEC 23094-2. LCEVC works by encoding a lower resolution (and potentially also lower bit depth) version of a source video using any existing codec (the “base codec”) and then coding the differences between the lower resolution video and the full resolution source, up to mathematically lossless coding if needed, using a different compression method (the “enhancement”).

This enhancement is achieved by a combination of processing an input video at a lower resolution with an existing single-layer codec and using a simple and small set of highly specialized tools to correct impairments, upscale and add details to the processed video.

An encoder 130 and its corresponding encoding process 131 is described now. The encoding process to create an LCEVC conformant bitstream and can be depicted in three major steps.

A base codec performs a first major step. Firstly, the input sequence is fed into two consecutive non-normative downscalers and is processed according to the chosen scaling modes. Any combination of the three available options (2-dimensional scaling, 1-dimensional scaling in the horizontal direction only or no scaling) can be used. The output then invokes the base codec which produces a base bitstream according to its own specification. This encoded base can be included as part of the LCEVC bitstream.

Enhancement sub-layer 1 performs a second major step. The reconstructed base picture may be upscaled to undo the downscaling process and is then subtracted from the first-order downscaled input sequence in order to generate the sub-layer 1 (L-1) residuals. These residuals form the starting point of the encoding process of the first enhancement sub-layer. A number of coding tools process the input and generate entropy encoded and quantized transform coefficients.

Enhancement sub-layer 2 implements a third major step. As a last step of the encoding process, the enhancement data for sub-layer 2 (L-2) needs to be generated. In order to create the residuals, the coefficients from sub-layer 1 are processed by an in-loop LCEVC decoder to achieve the corresponding reconstructed picture. Depending on the chosen scaling mode, the reconstructed picture is processed by an upscaler. Finally, the residuals are calculated by a subtraction of the input sequence and the upscaled reconstruction. Similar to sub-layer 1, the samples are processed by a few coding tools. In addition, a temporal prediction can be applied on the transform coefficients in order to achieve a better removal of redundant information. The entropy encoded quantized transform coefficients of sub-layer 2, as well as a temporal layer specifying the use of the temporal prediction on a block basis, are included in the LCEVC bitstream.

A decoder 140 and its corresponding decoding process 141 is described now. For the creation of the output sequence, the decoder analyses the LCEVC conformant bitstream. The process can again be divided into three parts:

A base codec performs the first step. In order to generate the Decoded Base Picture (Layer 0), the base decoder is fed with the extracted base bitstream. According to the chosen scaling mode in the configuration, this reconstructed picture might be upscaled and is afterwards called Preliminary Intermediate Picture.

Enhancement sub-layer 1 performs a second step. Following the base layer, the enhancement part needs to be decoded. Firstly, the coefficients belonging to enhancement sub-layer 1 are decoded using the inverse tools of the encoding process. Additionally, an L-1 filter might be applied in order to smooth the boundaries of a transform block. The output is then referred to as Enhancement Sub-Layer 1 and is added to the preliminary intermediate picture which results in the Combined Intermediate Picture. Again, depending on the scaling mode, an upscaler might be applied and the resulting Preliminary Output Picture has then the same dimensions as the overall output picture.

Enhancement sub-layer 2 performs a third step. As a final step, the second enhancement sub-layer is decoded. According to the temporal layer, a temporal prediction might be applied to the dequantized transform coefficients. This Enhancement Sub-Layer 2 is then added to the Preliminary Output Picture to form the Combined Output Picture as a final output of the decoding process.

A bitstream 101 structure is described now. The LCEVC bitstream contains a base layer, which may be at a lower resolution, and an enhancement layer consisting of up to two sub-layers. This subsection briefly explains the structure of this bitstream and how the information can be extracted. While the base layer can be created using any video encoder and is not specified further in the LCEVC specification, the enhancement layer is expected to follow the structure as specified. Similar to other MPEG codecs, the syntax elements are encapsulated in network abstraction layer (NAL) units which also help synchronize the enhancement layer information with the base layer decoded information. Depending on the position of the frame within a group of pictures (GOP), additional data specifying the global configuration and controlling the decoder may be present. The data of one enhancement picture is encoded into several chunks. These data chunks are hierarchically organized. For each processed plane (nPlanes), up to two enhancement sub-layers (nLevels) are extracted. Each of them again unfolds into numerous coefficient groups of entropy encoded transform coefficients. The amount depends on the chosen type of transform (nLayers). Additionally, if the temporal prediction is used, for each processed plane an additional chunk with temporal data for Enhancement sub-layer 2 is present.

MPEG-5 LCEVC has some similarities with a scalable codec (i.e., spatial scalability thanks to the upsampler) but it is also substantially different for the following reasons.

1) Generally, in a scalable codec, the base layer is encoded with the same standard of the enhancement layer. As specified in the description, LCEVC is codec agnostic. The base layer used in LCEVC can be any codec. This particular feature allows LCEVC to be used with any standard, such as H.264/AVC or H.266/VVC, and also with any other video codec (e.g., AV1, VP8, VP9 or the like).

2) The MPEG-5 LCEVC structure is using simple tools specifically designed for the sparse nature of the residual data which allow to keep the complexity low and limit the overhead associated with the enhancement layers, a common problem of scalable codecs. This makes it possible to have a software version of the MPEG-5 LCEVC that can run on existing hardware and on top of existing base codec with no need to develop a specific hardware for it. As a consequence, the base codec can work more efficiently and faster given the ability of LCEVC to work with a base codec running at a quarter of the resolution.

3) Differently to most of scalable codecs, MPEG-5 LCEVC provides two levels of enhancement that can be applied at different stages or resolutions. Each level has its own independent quantization module and sublayer of the bitstream that can easily decoupled from the other. This also allows bitrate allocation flexibility to cope with different type of content. It may be noted that MPEG-5 LCEVC offers up to two cascade scaling processes in order to further improve the efficiency of the base layer. Each scaler can be user defined, along the following degrees of freedom: kernel size, type of upscaling (i.e., which sub-layer, L-1 or L-2) and kernel values. MPEG-5 LCEVC offers 4 normative upsamplers and one 4 taps user defined kernel. Scalable codecs are generally offering only one fixed scaling engine and it is not programmable.

4) MPEG-5 LCEVC can manage different bit depths up to 14 bits per pixel in the main profile. The standard allows the base layer to work on a different bit depth compared to the input signal one. This operation can effectively enhance a base layer working at a lower bit depth to a higher one contributing to maintaining the fidelity of the input signal. An example of this application is delivering high dynamic range (HDR) with technologies that cannot deliver more than 8-bit per color component, like AVC High Profile.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

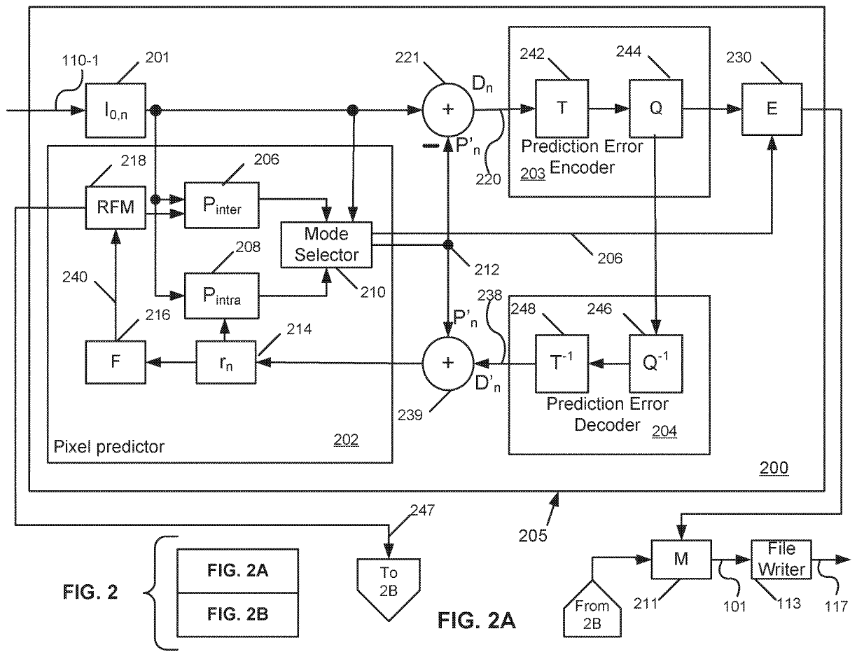

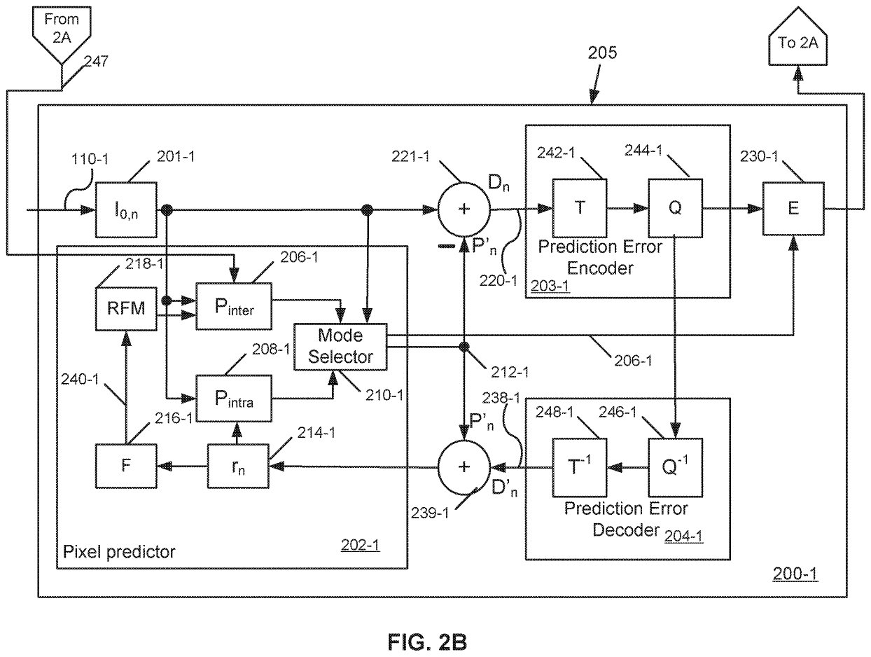

Referring to FIG. 2, which is split into FIGS. 2A and 2B, this figure illustrates a multilayer VVC encoder 205 which may be used to realize the examples herein. While a VVI encoder is shown, any video encoder which supports multilayer coding may be used. The examples may be implemented outside the encoder 205, e.g., in the file writer 113. This is discussed in more detail below. It is noted that the terms “image” and “picture” are considered to be the same herein. FIG. 2 presents an encoder 205 for two layers, but it would be appreciated that presented encoder 205 could be similarly extended to encode more than two layers. FIG. 2 illustrates an embodiment of a video encoder 205 comprising a first encoder section 200 for a base layer and a second encoder section 200-1 for an enhancement layer. The first encoder section 200 uses a normal numbering scheme, and the second encoder section 200-1 uses a numbering scheme where each element has a “−1” added. The elements in the two encoder sections 200 and 200-1 are the same or similar and will be described similarly herein except for the differences between the two. If an embodiment is used where there are left and right views (e.g., from respective viewpoints 10 and 11 of FIG. 1), then the line 247 from the RFM 218 of the first encoder section 200 to the second encoder section 200-1 would not be used, and instead video 110-1 from the left viewpoint 10 would be input as pictures (I_{0,n}) 201 in FIG. 2A and video 110-1 from the right viewpoint 11 would be input as pictures (I_{0,n}) 201-1 in FIG. 2B. Consider the following. If the left view is encoded in the base layer, an encoded right view may be formed that is based off of using the left view as a reference, e.g., enabling inter-layer picture prediction.

The encoders 200, 200-1 comprise pixel predictors 202, 202-1, prediction error encoders 203, 203-1, and prediction error decoders 204, 204-1. FIG. 2 also shows an embodiment of the pixel predictors 202, 202-1 as comprising inter-predictors (Pᵢₙₜₑᵣ) 206, 206-1, intra-predictors (Pᵢₙₜᵣₐ) 208, 208-1, mode selectors 210, 210-1, filters (F) 216, 216-1, and reference frame memories (RFMs) 218, 218-1. The pixel predictors 202, 202-1 of the encoders 200, 200-1 receive base layer pictures (I_{0,n}) 201, 201-1 of input video 110-1 (e.g., a video stream) to be encoded at both the inter-predictors 206, 206-1 (which determines the difference between the picture and a motion compensated reference frame from the RFMs 218, 218-1) and the intra-predictors 208, 208-1 (which determines a prediction for an image block based only on the already processed parts of the current picture from base layer picture 201, 201-1). The output of both the inter-predictors 206, 206-1 and the intra-predictors 208, 208-1 are passed to the mode selectors 210, 210-1. The intra-predictors 208, 208-1 may have more than one intra-prediction mode. Hence, each mode may perform the intra-prediction and provide the predicted signal to the mode selectors 210, 210-1. The mode selectors 210, 210-1 also receive a copy of the base layer pictures (I_{0,n}) 201, 201-1.

Depending on which encoding mode is selected to encode the current block, the output of the inter-predictor 206, 206-1, or the output of one of the intra-predictor 208, 208-1 modes, or the output of a surface encoder within the mode selector 210, 210-1 is passed to the output of the mode selector 210, 210-1. The output of the mode selector 210, 210-1 is passed to first summing device 221, 221-1 and comprises the prediction representation of the image block (P′ₙ) 212, 212-1. The first summing device 221, 221-1 may subtract the prediction representation of the image block (P′ₙ) 212, 212-1 of the pixel predictor 202, 202-1 from the base layer picture 201, 201-1 to produce a first prediction error signal (Dₙ) 220, 220-1, which is input to the prediction error encoder 203, 203-1.

The pixel predictor 202, 202-1 further receives from a second summing device 239, 239-1, which acts as a preliminary reconstructor, the combination of the prediction representation of the image block (P′ₙ) 212, 212-1 and the prediction error signal (D′ₙ) 238, 238-1 of the prediction error decoder 204, 204-1. The preliminary reconstructed picture (rₙ) 214, 214-1 may be passed to the intra-predictor 208, 208-1 and to a filter (F) 216, 216-1. The filter 216, 216-1 receiving the preliminary representation may filter the preliminary representation and output a final reconstructed picture 240, 240-1, which may be saved in the reference frame memory (RFM) 218, 218-1. The reference frame memory 218, 218-1 may be connected to the inter-predictor 206, 206-1 to be used as the reference picture against which a future base layer picture 201, 201-1 is compared in inter-prediction operations.

Subject to the base layer (e.g., first encoder section 200) being selected and indicated to be a source for inter-layer sample prediction and/or inter-layer motion information prediction of the enhancement layer (e.g., second encoder section 200-1) according to some embodiments, the reference frame memory 218 may also be connected to the inter-predictor 206-1 to be used as the reference image against which a future enhancement layer picture 201-1 is compared in inter-prediction operations. Moreover, the reference frame memory 218-1 may be connected to the inter-predictor 206-1 to be used as the reference image against which a future enhancement layer picture 201-1 is compared in inter-prediction operations.

Filtering parameters from the filter 216 of the first encoder section 200 may be provided to the second encoder section 200-1 subject to the base layer being selected and indicated to be source for predicting the filtering parameters of the enhancement layer according to some embodiments.

The prediction error encoder 203, 203-1 comprises a transform unit (T) 242, 242-1 and a quantizer (Q) 244, 244-1. The transform unit 242, 242-1 transforms the first prediction error signal 220, 220-1 to a transform domain. The transform is, for example, the DCT (discrete cosine transform). The quantizer 244, 244-1 quantizes the transform domain signal, e.g., the DCT coefficients, to form quantized coefficients.

The prediction error decoder 204, 204-1 receives the output from the prediction error encoder 203, and performs the opposite processes of the prediction error encoder 203, 203-1 to produce a decoded prediction error signal (D′ₙ) 238, 238-1 which, when combined with the prediction representation of the image block 212, 212-1 at the second summing device 239, 239-1, produces the preliminary reconstructed picture 214, 214-1. The prediction error decoder 204, 204-1 may be considered to comprise a dequantizer (Q⁻¹) 246, 246-1, which dequantizes the quantized coefficient values, e.g., DCT coefficients, to reconstruct the transform signal and an inverse transformation unit (T⁻¹) 248, 248-1, which performs the inverse transformation to the reconstructed transform signal wherein the output of the inverse transformation unit 248, 248-1 contains reconstructed block(s). The prediction error decoder 204, 204-1 may also comprise a block filter (not shown) which may filter the reconstructed block(s) according to further decoded information and filter parameters.

The entropy encoder 230, 230-1 receives the output of the prediction error encoder 203, 203-1 and may perform a suitable entropy encoding/variable length encoding to provide error detection and correction capability. The output of the entropy encoder 230, 230-1 can be influenced by the signaling 206, 206-1 from the mode selector 210, 210-1, e.g., which can indicate, e.g., whether inter prediction or intra prediction is being used. The output of the entropy encoder 230, 230-1 may be inserted into a bitstream 101, e.g., by a multiplexer 211. Entropy coding/decoding may be performed in many ways. For example, context-based coding/decoding may be applied, wherein both the encoder and the decoder modify the context state of a coding parameter based on previously coded/decoded coding parameters. Context based coding may for example be context adaptive binary arithmetic coding (CABAC), or context-based variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy-coded bitstream or codewords may be referred to as parsing.

The file writer 113 writes information into a box structured file 117. The box structured file 117 contains information about the encoded bitstream 101. The box structured file 117 may be an ISO file, for instance.

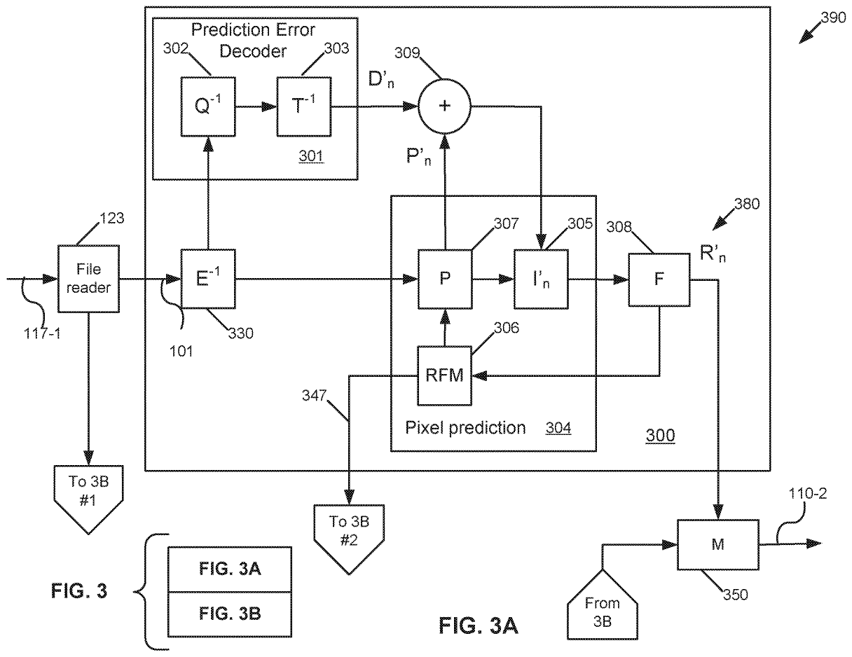

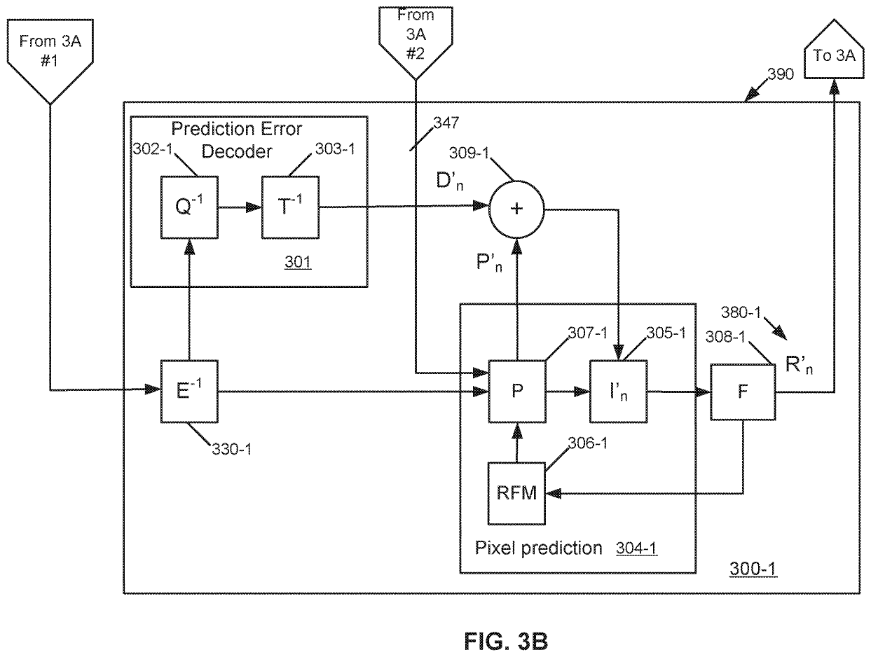

Referring to FIG. 3, which is split over FIGS. 3A and 3B, this figure illustrates a multilayer video decoder 390 where the decoder 140 examples can be implemented. FIG. 3 presents a video decoder 390 for two layers, but it would be appreciated that presented decoder 390 could be extended to decode more than two layers. It is to be understood that embodiments may be realized with any number of layers. FIG. 3 illustrates an embodiment of a video decoder 390 comprising a first decoder section 300 for a base layer and a second decoder section 300-1 for an enhancement layer. There is a file reader 123 that implements the examples herein, at least in part. The file reader 123 parses the information in the box structured file 117-1 that is received and extracts information to the bitstream 101, which is then fed to the corresponding decoder parts 300, 300-1. That is, the file reader 123 processes (e.g., by parsing) the box structured file 117-1 and sends information corresponding to the individual layers 300, 300-1 to the corresponding individual layer 300 or 300-1. This allows processing two or more output frames per time instance of the video information from a track (in a box of the box structured file 117-1) based at least on corresponding supplemental information in the box. This is described in more detail below. The box structured file 117-1 is a version of the transmitted box structured file 117, e.g., and may or may not contain errors after passing through a wired or wireless network.

The first decoder section 300 uses a normal numbering scheme, and the second decoder section 300-1 uses a numbering scheme where each element has a “−1” added. The elements in the two decoder sections 300 and 300-1 are the same or similar and will be described similarly herein except for the differences between the two. If an embodiment is used where there are left and right views (e.g., from respective viewpoints 10 and 11 of FIG. 1), then the line 347 from the RFM 306 of the first decoder section 300 to the second decoder section 300-1 would not be used. As described above, if the left view has been encoded in the base layer (e.g., sent to first decoder section 300 by the file reader 123), an encoded right view (e.g., sent to the second decoder section 300-1 by the file reader 123) may have already been formed that is based off of using the left view as a reference, e.g., enabling inter-layer picture prediction.

The video decoders 300, 300-1 are coupled to the bitstream 101. There is a prediction error decoder 301, 301-1 and a pixel prediction 304, 304-1. For the prediction error decoder 301, 301-1, block 303, 303-1 illustrates inverse transforms (T⁻¹), and block 302, 302-1 illustrates inverse quantization (Q⁻¹). Block 330, 330-1 illustrates entropy decoding (E⁻¹) that has an output for the pixel prediction 304, 304-1. Reference P′ₙ stands for a predicted representation of an image block. Reference D′ₙ stands for a reconstructed prediction error signal. In pixel prediction 304, 304-1, block 305, 305-1 illustrates preliminary reconstructed pictures (I′ₙ) based on the P′ₙ from block 307, 307-1 and the output of the adder 309, 309-1, while block 307, 307-1 illustrates prediction (P) (either inter-prediction or intra-prediction), which produces P′ₙ for the adder 309, 309-1 and as the block 305, 305-1. There is flow from the RFM 306 to the P 307-1, which illustrates inter-layer prediction for at least some examples herein. Block 330, 330-1 illustrates entropy decoding (E⁻¹). and block 306, 306-1 illustrates a reference frame memory (RFM). Adder 309, 309-1 may be used to combine decoded prediction error information (D′ₙ) with predicted base layer/predicted layer pictures (P′ₙ) to obtain the preliminary reconstructed pictures (I′ₙ) 305, 305-1. Block 308, 308-1 illustrates filtering (F) and reference R′ₙ stands for a final reconstructed picture 380, 380-1. A multiplexor M 350 is used to form at least part of the output video 110-2.

Now that an overview of the technical areas has been provided, a description of problems in this area is provided. A track in a file format is defined for video content that displays a single frame per time instance. Even in cases when a multilayer video bitstream is stored in a track, it was assumed that the extra layers are used for enhancement (quality, temporal), i.e., at the video decoder outputs and the application expects a single frame per time instance. With this assumption, a track provides a number of boxes with supplemental information about the output frame that can be used by the application. A multilayer video bitstream 101 is increasingly used to display two or more frames per time instance, e.g., two frames representing a left view 10 (see FIG. 1) and a right view 11 of a stereo representation of a scene 15/15-1 or two frames representing texture and depth information of a scene 15/15-1.

With that type of multilayer video bitstream 101, a track design in a file format lacks clear information as to which of the two or more output frames the boxes with supplemental information apply. Additionally, a track does not provide functionality to provide boxes with supplemental information that could be applied to two or more output frames, at given time instance.

Examples herein present multiple embodiments that describe how to introduce new, or extend old, boxes with supplemental information that can be used to process two or more output frames per time instance from a track in a file format.

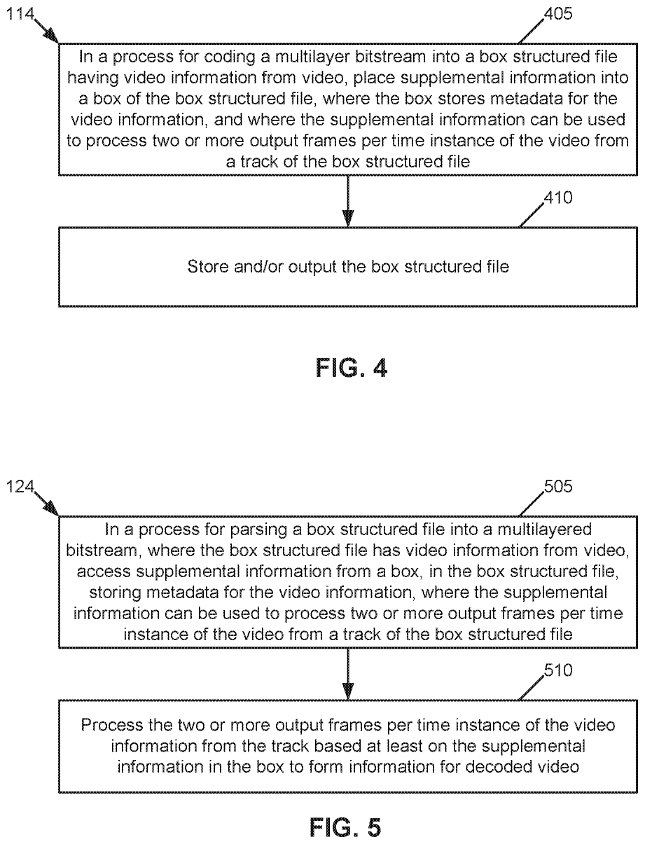

Turning to FIG. 4, this figure is a flow diagram of a process for coding a multilayer bitstream into a box structured file supporting the multilayer bitstream and allowing processing of two or more output frames per time instance from a track in a file format. This would be performed by the file writer 113 as part of the coding process 114. In operation 405, in a process for coding a multilayer bitstream into a box structured file having video information from video, the file writer 113 places supplemental information into a box of the box structured file. The box stores metadata for the video information. The supplemental information can be used to process two or more output frames per time instance of the video from a track of the box structured file. The storing is performed for subsequent outputting (or performing other processing prior to outputting) as encapsulated file 118.

Referring to FIG. 5, this figure is a flow diagram of a process for parsing a box structured file into a multilayer bitstream allowing processing of two or more output frames per time instance from a track in a file format. The operations in FIG. 5 are performed at least by the file reader 123 as part of the parsing process 124. In operation 505, the file reader 123, in a process 124 for parsing the box structured file 117-1 into a multilayer bitstream 101-1, where the box structured file has video information from video, accesses supplemental information from a box, in the box structured file 117-1, storing metadata for the video information. The supplemental information can be used to process two or more output frames per time instance of the video from a track of the box structured file. In block 510, the file reader 123 processes the two or more output frames per time instance of the video information from the track based at least on the supplemental information in the box to form information for decoded video. For instance, this processing can send information to the two layers 300, 300-1 of the multilayer video decoder 390, which allows the layers 300, 300-1 to further process the video information and allows additional processing of the two or more output frames per time instance of the video from the track of the box structured file.

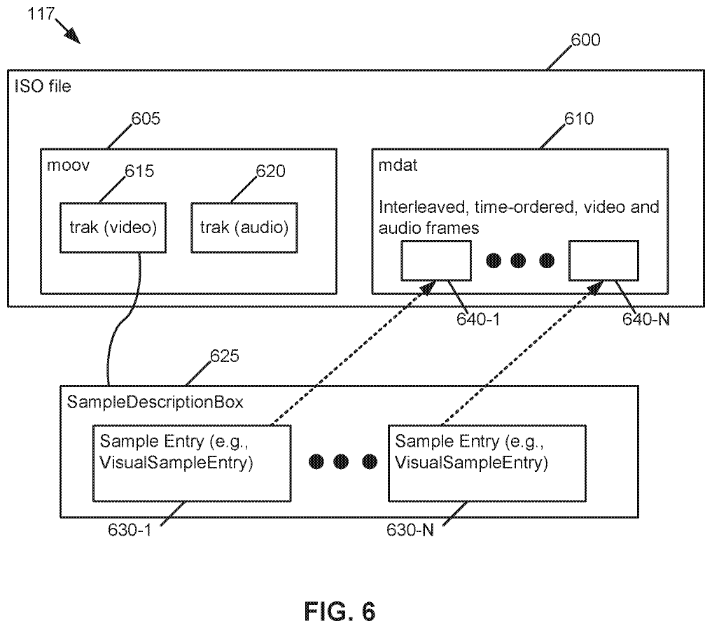

Certain of the embodiments are related to VisualSampleEntry. FIG. 6 is a block diagram of an ISO file 600, which is one version of box structured file 117, and a relationship to a sample entry of VisualSampleEntry used in an example. The ISO file 600 has a moov (movie) container 605 containing metadata (that is, data about data) about the video and comprising a video track (trak) 615 and an audio track (trak) 620, and an mdat container 610 containing the data for the video, and the mdat container 610 has interleaved, time-ordered video and audio frames. The video track 615 references a sample description box (SampleDescriptionBox) 625, with N sample entries 630-1 to 630-N. The sample entries 630 are individual versions of VisualSampleEntry in this example. Each of the sample entries 630-1 to 630-N references individual samples 640-1 to 640-N in the mdat container 610.

In an embodiment, when a multilayer bitstream is stored in a video track, the semantics of the parameter frame_count field in VisualSampleEntry field may be updated to have a value equal to 1 for each layer of the multilayer bitstream, indicating that each sample of the track can contain more than 1 frame with a maximum number equal to number of layers in the contained multilayer bitstream; alternatively the parameter frame_count may be set equal to maximum number of layers in the contained multilayer bitstream indicating that samples of the track may contain frames from zero and up to number of layers in the contained multilayer bitstream.

In an embodiment, when a multilayer bitstream is stored in a video track, the values of the parameters width and height fields in VisualSampleEntry field may be set based on the following.

1) In an embodiment, when the multilayer bitstream stored in the video track contains content having same or different resolutions in different layers and if the sample entry of the track is set such that it is backward compatible with the base layer (for example, when the base layer can be parsed, and decoded by any base layer compliant decoder/player) then the width and height fields are set based on the width and height fields of the base layer bitstream, respectively.

2) In an embodiment, when the multilayer bitstream stored in the video track contains content having same or different resolutions in different layers and if the sample entry of the track is set based on the multilayer bitstream then the width and height fields are set to the maximum among the decoded pictures; wherein the decoded pictures are determined by the information defined in the codec specific parameters. For example, if the multilayer bitstream is encoded with Layered HEVC the decoded pictures are defined by the output layer sets (OLS) in the VPS NAL unit and the specific OLS to be decoded is defined by the TargetOlsIdx. In another example, if the multilayer bitstream is encoded with AV1 (scalability is being used (OperatingPointIdc not equal to 0)) then the decoded pictures are determined by the operating point information present in the Sequence header OBU.

Layer information related embodiments are described now. These embodiments provide new boxes, for instance.

In an embodiment, a new box is defined that is called Layer Configuration box or Layer information Box with 4cc equal to ‘lcon’ or ‘lain’ (any other suitable name and 4cc may be used), which contains information related to one or more layers present in the video track.

In an embodiment, the Layer Configuration box may be present in the following: 1) the Track box(‘trak’) defining the information related to multilayer bitstream in the video track, or 2) the TrackHeaderBox(‘tkhd’) within a new version, for example, version=2 of the Track Header Box (e.g., Track Header Box is extended from the base class of FullBox which has two fields, version and flags; a new version of the trackheader box is defined, which will include one or more new parameters, to hold the information related to the multilayer bitstream in the video track, along with some other old parameters which are always present), or 3) the MediaBox(‘mdia’), a Track media structure, or 4) the MedialnformationBox(‘minf’), declaring the characteristics information of the media in the track, or 5) the SampleTableBox(‘stbl’), or 6) the SampleEntry of the track or the VisualSampleEntry in case of a video track, or 7) the SplitSamplesConfigurationBox in case split layers are used, or 8) the SampleEntry of SplitSampleDescriptionsBox in case split layers are used, or 9) SAIHeaderBox in case auxiliary samples are used.

In an embodiment, when the file is segmented/fragmented for streaming the Layer Configuration box may be present in the following: 1) in the TrackExtendsbox(‘trex’) within a new version, for example, version=1 of the TrackExtendsBox, or 2) in the TrackFragmentBox (‘traf’).

In an example embodiment, the structure of the Layer Configuration box as an extension of FullBox is defined as below.

```
aligned(8) class LayerConfigurationBox
    extends FullBox(‘lcon’, version=0, tf_flags=0)
  {
    unsigned int(8) num_layers;
    for (i=0; i<num_layers; i++) {
      bit(2) reserved = 0;
      unsigned int(6) layer_id;
      unsigned int(8) box_count; // count of boxes in this loop entry
      // other boxes from derived specifications
```

| CleanApertureBox | clap; | // optional |
|---|---|---|
| PixelAspectRatioBox | pasp; | // optional |
| ColorInformationBox cinf; | // optional | |
| ContentLightLevelBox clle; | | // optional |

MasteringDisplayColorVolumeBox mdcv; //optional

| | |
|---|---|
| ContentColorVolumeBox ccvo; | //optional |
| AmbientViewingEnvironmentBox aven; | //optional |

```
    }
  }
```

In an embodiment, both the version and flag fields of the FullBox structure are set to 0.

In an alternate example embodiment, the structure of the Layer Configuration box as an extension of Box is defined as below.

```
aligned(8) class LayerConfigurationBox
    extends Box(‘lcon’)
  {
    unsigned int(2) version=0;
    unsigned int(6) num_layers;
    for (i=0; i<num_layers; i++) {
      bit(2) reserved = 0;
      unsigned int(6) layer_id;
      unsigned int(8) box_count; // count of boxes in this loop entry
      // other boxes from derived specifications
```

| CleanApertureBox | clap; | // optional |
|---|---|---|
| PixelAspectRatioBox | pasp; | // optional |
| ColorInformationBox cinf; | // optional | |
| ContentLightLevelBox clle; | | // optional |

MasteringDisplayColorVolumeBox mdcv; //optional

| | |
|---|---|
| ContentColorVolumeBox ccvo; | //optional |
| AmbientViewingEnvironmentBox aven; | //optional |

```
    }
  }
```

In another alternate example embodiment, boxes describing layer properties are included in a box and associated with indexes. The association of indexes may be performed in appearance order of boxes describing layer properties. The value space of indexes may be scoped by the four-character of the box describing layer properties or may be shared by all boxes describing layer properties regardless of the four-character code. The indexes may start from a pre-defined value, such as 1. Boxes that are directly present in the sample entry may be assigned pre-defined value(s), such as 0. In an example, a LayerPropertyContainerBox may comprise boxes describing layer properties and may be defined as follows. The container for LayerPropertyContainerBox may be, for example, the same as for the LayerConfigurationBox or may be the LayerConfigurationBox itself.

```
aligned(8) class LayerPropertyContainerBox extends Box(‘lpco’)
  {
    // zero or more instances of any boxes that describe layers
```

| CleanApertureBox | clap; | // optional |
|---|---|---|
| PixelAspectRatioBox | pasp; | // optional |
| ColorInformationBox cinf; | // optional | |
| ContentLightLevelBox clle; | | // optional |

MasteringDisplayColorVolumeBox mdcv; //optional

| | |
|---|---|
| ContentColorVolumeBox ccvo; | //optional |
| AmbientViewingEnvironmentBox aven; | //optional |

}

The LayerConfigurationBox may associate layer properties to a layer by listing index(es) of the box(es) describing layer properties and, when the value space of indexes is specific to box type, the respective box-type four-character code(s). In this case, the structure of the LayerConfigurationBox may be defined as below:

```
aligned(8) class LayerConfigurationBox
    extends FullBox(‘lcon’, version=0, tf_flags=0)
  {
    unsigned int(8) num_layers;
    for (i=0; i<num_layers; i++) {
      bit(2) reserved = 0;
      unsigned int(6) layer_id;
      unsigned int(8) num_layer_prop;
      for (j=0; j<num_layer prop; j++) {
        unsigned int(32) prop_4cc;
        unsigned int(8) prop_idx;
      }
    }
  }
```

In an embodiment, num_layers indicates the number of layers of a multilayer bitstream contained in the track for which the layer configuration information is defined. Consider the following: 1) In an embodiment, num_layers may be equal to number of layers of a multilayer bitstream contained in the track (including the base layer and all the other layers); or 2) num_layers may be one less than the number of layers of a multilayer bitstream contained in the track (excluding the base layer but including all the other layers); or 3) num_layers may be less than the number of layers of a multilayer bitstream contained in the track (a subset of layers among all the layers).

In an embodiment, the layer_id indicated the id of the layer within the multilayer bitstream contained in the track for which the layer information is signaled.

In an embodiment, the following boxes may be optionally present in the layer configuration box: 1) CleanApertureBox; 2) PixelAspectRatioBox; 3) ColorInformationBox; 4) ContentLightLevelBox; 5) MasteringDisplayColorVolumeBox; 6) ContentColorVolumeBox; and/or 7) AmbientViewingEnvironmentBox.

In an embodiment, presence of the above boxes may be identified by the 4cc of the box.

In an alternate embodiment, the presence of the above boxes may be gated by the tf_flag of the layer configuration box.

In another alternate embodiment, the presence of the above boxes may be gated by setting of the box flags within the layer configuration box.

In an example embodiment, the presence of the above boxes gated by the tf_flag is defined below.

The following flags are defined in the tf_flags:
1) 0x000001—clean-aperture-box-present: indicates the presence of the CleanApertureBox for all the layers indicated in the layer configuration box;
2) 0x000002—pixel-aspect-ratio-box-present: indicates the presence of the PixelAspectRatioBox for all the layers indicated in the layer configuration box;
3) 0x000003—color-info-box-present: indicates the presence of the ColorInformationBox for all the layers indicated in the layer configuration box;
4) 0x000004—content-light-level-box-present: indicates the presence of the ContentLightLevelBox for all the layers indicated in the layer configuration box;
5) 0x000005—mastering-display-color-volume-box-present: indicates the presence of the MasteringDisplayColorVolumeBox for all the layers indicated in the layer configuration box;
6) 0x000006—content-color-volume-box-present: indicates the presence of the ContentColorVolumeBox for all the layers indicated in the layer configuration box;
7) 0x000007—ambient-viewing-env-box-present: indicates the presence of the AmbientViewingEnvironmentBox for all the layers indicated in the layer configuration box.

In an example embodiment, the presence of the above boxes gated by setting of the box flags within the layer configuration box is defined below.

```
{
  Bit(1) reserved = 0;
  Unsigned int(1) clean_aperture_present_flag;
  Unsigned int(1) pixel_aspect_ratio_present_flag;
  Unsigned int(1) color_information_present_flag;
  Unsigned int(1) content_light_level_present_flag;
  Unsigned int(1) mastering_display_color_volume_present_flag;
  Unsigned int(1) content_color_volume_present_flag;
  Unsigned int(1) ambient_viewing_env_present_flag;
  if (clean_aperture_present_flag)
    CleanApertureBox clap;
  if (pixel_aspect ratio_present_flag)
    PixelAspectRatioBox pasp;
  if (color_information_present_flag)
    ColorInformationBox cinf;
  if (content_light_level_present_flag)
    ContentLightLevelBox clle;
  if (mastering_display_color_volume_present_flag)
    MasteringDisplayColorVolumeBox mdcv;
  if (content_color_volume_present_flag)
    ContentColorVolumeBox ccvo;
  if (ambient_viewing_env_present_flag)
    AmbientViewingEnvironmentBox aven;
}
```

In an embodiment, if the clean_aperture_present_flag is set to 1, this indicates that CleanApertureBox is present for the specific layer_id. If the clean_aperture_present_flag is set to 0, this indicates that CleanApertureBox is not present for the specific layer_id.

In an embodiment, if the pixel_aspect_ratio_present_flag is set to 1, this indicates that PixelAspectRatioBox is present for the specific layer_id. If the pixel_aspect_ratio_present_flag is set to 0, this indicates that PixelAspectRatioBox is not present for the specific layer_id.

In an embodiment, if the color_information_present_flag is set to 1, this indicates that ColorInformationBox is present for the specific layer_id. If the color_information_present_flag is set to 0, the indicates that ColorInformationBox is not present for the specific layer_id.

In an embodiment, if the content_light_level_present_flag is set to 1, this indicates that ContentLightLevelBox is present for the specific layer_id. If the content_light_level_present_flag is set to 0, this indicates that ContentLightLevelBox is not present for the specific layer_id.

In an embodiment, if the mastering_display_color_volume_present_flag is set to 1, this indicates that MasteringDisplayColorVolumeBox is present for the specific layer_id. If the mastering_display_color_volume_present_flag is set to 0, this indicates that MasteringDisplayColorVolumeBox is not present for the specific layer_id.

In an embodiment, if the content_color_volume_present_flag is set to 1, this indicates that ContentColorVolumeBox is present for the specific layer_id. If the content_color_volume_present_flag is set to 0, this indicates that ContentColorVolumeBox is not present for the specific layer_id.

In an embodiment, if the ambient_viewing_env_present_flag is set to 1, this indicates that AmbientViewingEnvironmentBox is present for the specific layer_id. If the ambient_viewing_env_present_flag is set to 0, this indicates that AmbientViewingEnvironmentBox is not present for the specific layer_id.

In an embodiment when a clean_aperture_present_flag, pixel_aspect_ratio_present_flag, color_information_present_flag, content_light_level_present_flag, mastering_display_color_volume_present_flag, content_color_volume_present_flag, or ambient_viewing_env_present_flag is set to 0, this indicates that corresponding box is not present for a given layer and information from base layer is re-used.

In an alternate embodiment when a clean_aperture_present_flag, pixel_aspect_ratio_present_flag, color_information_present_flag, content_light_level_present_flag, mastering_display_color_volume_present_flag, content_color_volume_present_flag, or ambient_viewing_env_present_flag is set to 0, this indicates that corresponding box is not present for a given layer. The file reader may use the information, if present, from the base layer to the remaining layers or extract the information for the remaining layers from the structures specific to video codec (if any) or from the containing multilayer bitstream or if the file reader is unable to extract such information from the structures specific to video codec (if any) or from the containing multilayer bitstream then discard the processing of layers for which the information is not available.

In an example embodiment, the presence of the above boxes, gated by setting of the box flags within the layer configuration box, and if not present the information which layer boxes to re-use, is provided by reference_layer_id syntax element as defined below.

```
{
  Bit(1) reserved = 0;
  Unsigned int(1) clean_aperture_present_flag;
  Unsigned int(1) pixel_aspect_ratio_present_flag;
  Unsigned int(1) color_information_present_flag;
  Unsigned int(1) content_light_level_present_flag;
  Unsigned int(1) mastering_display_color_volume_present_flag;
  Unsigned int(1) content_color_volume_present_flag;
  Unsigned int(1) ambient_viewing_env_present_flag;
  if(clean_aperture_present_flag){
```

| | |
|---|---|
| CleanApertureBox | clap; |

```
  } else {
    unsigned int(6) reference_layer_id;
  }
  if(pixel_aspect_ratio_present_flag){
```

| | |
|---|---|
| PixelAspectRatioBox | pasp; |

```
  } else {
    unsigned int(6) reference_layer_id;
  }
  if(color_information present_flag){
    ColorInformationBox cinf;
  } else {
    unsigned int(6) reference_layer_id;
  }
  if(content_light_level_present_flag){
    ContentLightLevelBox clle;
  } else {
    unsigned int(6) reference_layer_id;
  }
  if(mastering_display_color_volume_present_flag){
    MasteringDisplayColorVolumeBox mdcv;
  } else {
    unsigned int(6) reference_layer_id;
  }
  if(content_color_volume_present_flag){
    ContentColorVolumeBox ccvo;
  } else {
    unsigned int(6) reference_layer_id;
  }
  if(ambient_viewing_env_present_flag){
    AmbientViewingEnvironmentBox aven;
  } else {
    unsigned int(6) reference_layer_id;
  }
}
```

In an embodiment, the Layer Configuration box may be present in the following: 1) the MovieBox(‘moov’), or 2) the Movie header Box(‘mvhd’) within a new version, for example, version=2 of the Movie header Box.

In an embodiment, when the file is segmented/fragmented for streaming the Layer Configuration box may be present in: 1) the MovieExtendsBox(‘mvex’), or 2) the MovieExtendsHeaderBox(‘mehd’) within a new version, for example, version=2 of the Movie Extends Header Box, or 3) MovieFragmentBox (‘moof’), or 4) MovieFragmentHeaderBox(‘mfhd’) within a new version, for example, version=1 of the Movie Fragment Header Box.

In an embodiment, if the Layer Configuration box is present in either MovieBox or MovieHeaderBox or MovieExtendsBox or MovieExtendsHeaderBox or MovieFragmentHeaderBox, then the Layer Configuration box contains signaling about mapping the information contained in the Layer Configuration box to the tracks in the movie boxes. The mapping may be signaled by carrying the trackID (track identification) value of the track within the movie to which the layer configuration information belongs to or by carrying an index to the track within the movie to which the layer configuration information belongs.

In an embodiment, when the multilayer bitstream stored in the video track contains content having different resolutions in different layers and if the sample entry of the track is set such that it is backward compatible with the base layer (for example, when the base layer can be parsed, and decoded by any base layer compliant decoder/player), then the Layer Configuration box may additionally carry the width and height fields for the remaining layers of the multilayer bitstream. The width and height fields may be optionally present in the layer configuration box gated by a flag, where the setting of the flag to 1 may indicate the presence of width and height fields, and where setting of the flag to 0 indicates that the width and height fields are not present for a specific layer in the layer configuration box.

In an embodiment, when the multilayer bitstream stored in the video track contains content having different resolutions in different layers and, if the sample entry of the track is set such that it is backward compatible with base layer (for example, when the base layer can be parsed, and decoded by any base layer compliant decoder/player), and, if the Layer Configuration box does not signal the width and height field for a specific layer_id, this indicates that the width and height of the specific layer_id is same as the width and height of the base layer, respectively.

In an embodiment, when multilayer bitstream is contained in a video track and if the video track contains the Pixel Aspect Ratio sample group (‘pasr’), it may signal the pixel aspect ratio of only the base layer in the samples of the video track. In an alternate embodiment, when multilayer bitstream is contained in a video track and if the video track contains the Pixel Aspect Ratio sample group (‘pasr’), it may signal the pixel aspect ratio of all the layers in the samples of the video track.

In an embodiment, when multilayer bitstream is contained in a video track and if the Pixel Aspect Ratio of the samples in the track change dynamically and if the pixel aspect ratio of the layers in the track is different from each other; the grouping_type_parameter of the SampleToGroupBox with grouping_type equal ‘pasr’ indicates to which specific layer among all the layers present in the video track, the Pixel Aspect Ratio sample group (‘pasr’) belong. The said grouping_type_parameter carries the layer_id of the specific layer to which the Pixel Aspect Ratio sample group (‘pasr’) belong to. In an alternate embodiment, if multiple Pixel Aspect Ratio sample group (‘pasr’) is present in the same fragment for a specific layer the grouping_type_parameter may start at 0x10001, i.e., the layer_id with value 1, with the value 1 in the top 16 bits. This means there must be fewer than 65536 layer_id values for this track and grouping_type in the SampleTableBox of the track.

In an embodiment, when multilayer bitstream is contained in a video track and if the video track contains the Clean Aperture sample group (‘casg’), it may signal the clean aperture of only the base layer in the samples of the video track. In an alternate embodiment, when multilayer bitstream is contained in a video track and if the video track contains the Clean Aperture sample group (‘casg’), it may signal the clean aperture of all the layers in the samples of the video track.

In an embodiment, when multilayer bitstream is contained in a video track and if the Clean Aperture of the samples in the track change dynamically and if the Clean Aperture of the layers in the track is different from each other; the grouping_type_parameter of the SampleToGroupBox with grouping_type equal ‘casg’ indicates to which specific layer among all the layers present in the video track, the clean aperture sample group (‘casg’) belong to. The said grouping_type_parameter carries the layer_id of the specific layer to which clean aperture sample group (‘casg’) belong to. In an alternate embodiment, if multiple clean aperture sample group (‘casg’) is present in the same fragment for a specific layer the grouping_type_parameter may start at 0x10001, i.e., the layer_id with value 1, with the value 1 in the top 16 bits. This means there must be fewer than 65536 layer_id values for this track and grouping_type in the SampleTableBox of the track.

In an embodiment, a new box is defined that is called Layer Configuration sample group info box or Layer sample group information Box with 4cc equal to ‘lcsi’ or ‘lsgi’ (any other suitable name and 4cc may be used), which contains information related to sample groups for one or more layers present in the video track.

In an embodiment, the Layer sample group information Box may be present in the following: 1) the SampleTableBox(‘stbl’),or 2) the SampleGroupDescriptionBox within the entry_count loop together with the SampleGroupDescriptionEntry for a specific grouping_type, or 3) within the SampleGroupDescriptionEntry for example within the VisualSampleGroupEntry of the video track with a specific grouping_type, or 4) the information (fields and parameters) defined in Layer sample group information box is present in the SplitSampleLayerConfigBox or in the SplitLayerBox or in the SplitSamplesConfigurationBox or in the SplitSampleDescriptionsBox or in the sampleentry contained in the SplitSampleDescriptionsBox or 5) in the SAIHeaderBox.

In an example embodiment, the structure of the Layer sample group information box as an extension of FullBox is defined as below.

```
aligned(8) class LayerSampleGroupInformationBox
    extends FullBox(‘lsgi’, version=0, tf_flags=0)
  {
    unsigned int(8) num_layers;
    for (i=0; i<num_layers; i++) {
      bit(2) reserved = 0;
      unsigned int(6) layer_id;
      unsigned int(8) box_count; // count of boxes in this loop entry
      // other boxes from derived specifications
```

| | | |
|---|---|---|
| PixelAspectRatioEntry | clap; | // optional |
| CleanApertureEntry | pasp; | // optional |

```
    }
  }
```

In an embodiment, both the version and flag fields of the FullBox structure are set to 0.

In another alternate example embodiment, boxes describing sample group of the layer are included in a box and associated with indexes. The association of indexes may be performed in appearance order of boxes describing sample group of the layer. The value space of indexes may be scoped by the four-character of the box describing sample group of the layer or may be shared by all boxes describing sample group of the layers regardless of the four-character code. The indexes may start from a pre-defined value, such as 1. Sample groups that are directly present in the sampletogroupbox and sample group description entry may be assigned pre-defined value(s), such as 0. In an example, a LayerSampleGroupContainerBox may comprise boxes describing sample groups of the layers and may be defined as follows. The container for LayerSampleGroupContainerBox may be, for example, the same as for the LayerConfigurationBox or may be the LayerConfigurationBox itself or any of the following boxes: 1) the SampleTableBox(‘stbl’),or 2) the SampleGroupDescriptionBox within the entry_count loop together with the SampleGroupDescriptionEntry for a specific grouping_type, or 3) within the SampleGroupDescriptionEntry for example within the VisualSampleGroupEntry of the video track with a specific grouping_type, or 4) the information (fields and parameters) defined in Layer sample group information box is present in the SplitSampleLayerConfigBox or in the SplitLayerBox or in the SplitSamplesConfigurationBox or in the SplitSampleDescriptionsBox or in the sampleentry contained in the SplitSampleDescriptionsBox or 5) in the SAIHeaderBox.

```
aligned(8) class LayerSampleGroupContainerBox extends Box(‘lsco’)
  {
    // zero or more instances of any boxes that describe layers
```

| | | |
|---|---|---|
| PixelAspectRatioEntry | clap; | // optional |
| CleanApertureEntry | pasp; | // optional |

}

The LayerSampleGroupInformationBox may associate sample groups to a layer by listing index(es) of the box(es) describing sample groups and, when the value space of indexes is specific to box type, the respective box-type four-character code(s). In this case, the structure of the LayerSampleGroupInformationBox may be defined as below:

```
aligned(8) class LayerSampleGroupInformationBox
    extends FullBox(‘lsgi’, version=0, tf_flags=0)
  {
    unsigned int(8) num_layers;
    for (i=0; i<num_layers; i++) {
      bit(2) reserved = 0;
      unsigned int(6) layer_id;
      unsigned int(8) num_layer_samplegroups;
      for (j=0; j<num_layer_ samplegroups; j++) {
        unsigned int(32) sg_4cc;
        unsigned int(8) sg_idx;
      }
    }
  }
```

In an embodiment, num_layers indicates the number of layers of a multilayer bitstream contained in the track for which the layer sample group information is defined. Consider the following:

1) In an embodiment, num_layers may be equal to number of layers of a multilayer bitstream contained in the track (including the base layer and all the other layers); or

2) num_layers may be one less than the number of layers of a multilayer bitstream contained in the track (excluding the base layer but including all the other layers); or

3) num_layers may be less than the number of layers of a multilayer bitstream contained in the track (a subset of layers among all the layers).

In an embodiment, the layer_id indicated the id of the layer within the multilayer bitstream contained in the track for which the layer information is signaled.

In an embodiment, the following boxes may be optionally present in the LayerSampleGroupInformationBox: 1) CleanApertureEntry; 2) PixelAspectRatioEntry;

In an embodiment, presence of the above boxes may be identified by the 4cc of the box. In an alternate embodiment, the presence of the above boxes may be gated by the tf_flag of the layer configuration box. In another alternate embodiment, the presence of the above boxes may be gated by setting of the box flags within the LayerSampleGroupInformationBox.

In an example embodiment, the presence of the above boxes gated by the tf_flag is defined below.

The following flags are defined in the tf_flags: 1) 0x000001—clean-aperture-entry-present: indicates the presence of the CleanApertureEntry for all the layers indicated in the LayerSampleGroupInformationBox; 2) 0x000002—pixel-aspect-ratio-entry-present: indicates the presence of the PixelAspectRatioEntry for all the layers indicated in the LayerSampleGroupInformationBox;

In an example embodiment, the presence of the above boxes gated by setting of the box flags within the LayerSampleGroupInformationBox is defined below.

```
{
  Bit(6) reserved = 0;
  Unsigned int(1) clean_aperture_present_flag;
  Unsigned int(1) pixel_aspect_ratio_present_flag;
  if (clean_aperture_present_flag)
    CleanApertureEntry clap;
  if (pixel_aspect_ratio_present_flag)
    PixelAspectRatioEntry pasp;
}
```

In an embodiment, if the clean_aperture_present_flag is set to 1, this indicates that CleanApertureEntry is present for the specific layer_id. If the clean_aperture_present_flag is set to 0, this indicates that CleanApertureEntry is not present for the specific layer_id.

In an embodiment, if the pixel_aspect_ratio_present_flag is set to 1, this indicates that PixelAspectRatioEntry is present for the specific layer_id. If the pixel_aspect_ratio_present_flag is set to 0, this indicates that PixelAspectRatioEntry is not present for the specific layer_id.

In an embodiment when a clean_aperture_present_flag, pixel_aspect_ratio_present_flag, is set to 0, this indicates that corresponding sample group entries is not present for a given layer and information from base layer is re-used.

In an alternate embodiment when a clean_aperture_present_flag, pixel_aspect_ratio_present_flag, is set to 0, this indicates that corresponding sample group entry is not present for a given layer. The file reader may use the information, if present, from the base layer to the remaining layers or extract the information for the remaining layers from the structures specific to video codec (if any) or from the containing multilayer bitstream or if the file reader is unable to extract such information from the structures specific to video codec (if any) or from the containing multilayer bitstream then discard the processing of layers for which the information is not available.

In an example embodiment, the presence of the above boxes, gated by setting of the box flags within the LayerSampleGroupInformationBox, and if not present the information which layer boxes to re-use, is provided by reference_layer_id syntax element as defined below.

```
{
  Bit(6) reserved = 0;
  Unsigned int(1) clean_aperture_present_flag;
  Unsigned int(1) pixel_aspect_ratio_present_flag;
  if(clean_aperture_present_flag){
    CleanApertureEntry clap;
  } else {
    unsigned int(6) reference_layer_id;
  }
  if(pixel_aspect_ratio_present_flag){
    PixelAspectRatioEntry pasp;
  } else {
    unsigned int(6) reference_layer_id;
  }
}
```

In an embodiment, when multilayer bitstream is contained in a video track, the pixel aspect ratio and clean aperture for each layer of the video may be specified using the PixelAspectRatioBox and CleanApertureBox where these boxes may be present in the sample entry boxes (for example for the base layer) or in any of the boxes defined above (for example LayerConfigurationBox). In an embodiment, the PixelAspectRatioBox and CleanApertureBox for each layer is optional; if present (for all the layers or only a subset of layers), they over-ride the declarations (if any) in structures specific to the video codec, which structures should be examined if these boxes are absent. In an embodiment, for maximum compatibility, the PixelAspectRatioBox and CleanApertureBox for each layer should follow, not precede, any boxes defined in or required by derived specifications.

In an embodiment, when multilayer bitstream is contained in a video track, the images output by the decoder for each layer may be re-formatted to the dimensions in the track header. In an alternate embodiment, when multilayer bitstream is contained in a video track, the LayerConfigurationBox may additionally contain information that each layer which is output by the decoder is reformatted to the dimensions in the track header as follows:

```
{
  unsigned int(8) num_layers;
  for (i=0; i<num_layers; i++) {
    bit(1) reserved = 0;
    unsigned int(6) layer_id;
    unsigned int(1) formatted_to_track_header_flag;
    if (!formatted_to_track_header_flag) {
      unsigned int(32) width;
        unsigned int(32) height;
    }
  }
}
```

In an embodiment, when formatted_to_track_header_flag is set to 1, it indicates that the images output by the decoder having layer id equal to layer_id is re-formatted to the dimensions in the track header. In an embodiment, when formatted_to_track_header_flag is set to 0, it indicates that the images output by the decoder having layer id equal to layer_id is not re-formatted to the dimensions in the track header but is re-formatted to the dimensions defined by the LayerConfigurationBox. In an embodiment, the PixelAspectRatioBox is informative; for each layer if the decoded output of the codec is re-formatted to the dimensions in the track header or to the dimensions defined in LayerConfigurationBox, the said PixelAspectRatioBox will accomplish any needed adjustment to a uniformly-scaled grid.

In an embodiment, when multilayer bitstream is contained in a video track the processing of the decoded pixel for each layer is assumed to be as follows:
a) Any cropping documented by a CleanApertureBox for each layer is applied on the pixels output for the specific layer by the decoder,
b) Then for each layer, if a CleanApertureBox is present, the cropped image is then scaled as below:
If, for the said layer, the dimensions are to be re-formatted based on the dimensions in the track header then horizontally by the factor TrackHeaderBox.width/CleanAperture.width and vertically by TrackHeaderBox.height/CleanAperture.height, or
If, for the said layer, the dimensions are to be re-formatted based on the dimensions in the LayerConfigurationBox then horizontally by the factor LayerConfigurationBox.width/CleanAperture.width and vertically by LayerConfigurationBox.height/CleanAperture.height.
c) Otherwise, if a CleanApertureBox is not present, the decoded image is then scaled as below:
i) If for the said layer the dimensions are to be re-formatted based on the dimensions in the track header then horizontally by the factor TrackHeaderBox.width/SampleEntry.width and vertically by TrackHeaderBox.height/SampleEntry.height, or
ii) If for the said layer the dimensions are to be re-formatted based on the dimensions in the LayerConfigurationBox then horizontally by the factor LayerConfigurationBox.width/SampleEntry.width and vertically by LayerConfigurationBox.height/SampleEntry.height.

d) The matrix of the TrackHeaderBox is then applied.

e) All visual tracks are superposed in increasing order of the TrackHeaderBox.layer value.

f) The matrix of the MovieHeaderBox is then applied to the composition.

In an embodiment, when multilayer bitstream is contained in a video track the Colour (e.g., a British English spelling of this word “color”) information for each layer may be supplied in one or more ColourInformationBoxes. The ColourInformationBoxes may be placed in a VisualSampleEntry or in the LayerConfigurationBox as defined above. In an embodiment, ColourInformationBoxes should be placed in order in the sample entry or in the LayerConfigurationBox starting with the most accurate (and potentially the most difficult to process), in progression to the least. These are advisory and concern rendering and colour conversion, and there is no normative behaviour associated with them; a reader may choose to use the most suitable. A ColourInformationBox with an unknown colour type may be ignored. If used, an ICC profile may be a restricted one, under the code ‘rICC’, which permits simpler processing. That profile may be of either the monochrome or three-component matrix-based class of input profiles. If the profile is of another class, then the ‘prof’ indicator is used. If colour information is supplied in both this box, and also in the video bitstream, this box takes precedence, and over-rides the information in the bitstream.

In an embodiment, when multilayer bitstream is contained in a video track the ContentLightLevelBox may be used to provide information about the light level in the content for each layer and may be present in a VisualSampleEntry and/or in the LayerConfigurationBox. It is functionally equivalent to the content light level information SEI message with the addition that the provisions of CTA-861-G, in which zero in some cases codes an unknown value, may be used.

In an embodiment, when a multilayer bitstream is contained in a video track the MasteringDisplayColourVolumeBox may be used to provide information about the colour primaries, white point, and mastering luminance in the content for each layer and may be present in a VisualSampleEntry and/or in the LayerConfigurationBox. It is functionally equivalent to the mastering display colour volume SEI message with the addition that the provisions of CTA-861-G in which zero in some cases codes an unknown value may be used.

In an embodiment, when multilayer bitstream is contained in a video track the ContentColourVolumeBox describes the colour volume characteristics of the associated pictures for each layer. These colour volume characteristics are expressed in terms of a nominal range, although deviations from this range may occur. It is functionally equivalent to the content colour volume SEI message except that the box, in a sample entry and/or in the LayerConfigurationBox, applies to the associated content with a specific layer and hence the initial two bits (corresponding to the ccv_cancel_flag and ccv_persistence_flag) take the value 0.

In an embodiment, when multilayer bitstream is contained in a video track the AmbientViewingEnvironmentBox may be used to provide information about the characteristics of the nominal ambient viewing environment for the display of the associated video content for each layer and may be present in a VisualSampleEntry and/or in the LayerConfigurationBox. The syntax elements of the ambient viewing environment box may assist the receiving system in adapting the received video content for local display in viewing environments that may be similar or may substantially differ from those assumed or intended when mastering the video content. It is functionally equivalent to the ambient viewing environment SEI message in ITU-T H.265 ISO/IEC 23008-2.

Multilayer related scheme signaling is described now. In an embodiment, when a multilayer bitstream is contained in a video track a new multilayer scheme_type is defined with 4cc ‘mlvi’ called multilayer video (any other 4cc value which indicates the presence of multilayer bitstream may be used). In an embodiment, the scheme_type equal to ‘mlvi’ indicates that when multilayer video frames are decoded, the decoded frames contains images from different layers, where each layer may contain video with different quality or resolution or bit-depth or a combination of them or each layer may form a part of stereoscopic pair or each layer may be videos from different viewpoints (that is, may include video from different viewpoints) or each layer may be a part of video and depth pair or video and alpha pair or a combination of them. In an embodiment, information related to multilayer coding may be present in the LayerConfigurationBox, where the LayerConfigurationBox may be present in the SchemeInformationBox when the scheme_type is ‘mlvi’.

In an embodiment, when multilayer bitstream is contained in a video track the LayerConfigurationBox may be further extended to include information about the content of each layer as follows:

```
{
  unsigned int(8) num_layers;
  for (i=0; i<num_layers; i++) {
    bit(2) reserved = 0;
    unsigned int(6) layer_id;
    unsigned int(8) content_type;
  }
}
```

In an embodiment, content type may indicate the type of the content in each layer for example a value of 0 may indicate the content type to be video and a value of 1 may indicate content type to be depth similar a specific of content type may be choose to indicate that the video in the specific layer with layer_id may be the right view of the stereoscopic pair and a different value of the content type may be choose to indicate that the video in the specific layer with layer_id may be the left view of the stereoscopic pair. A value of content type may similarly be chosen to indicate the presence of alpha channel.

In an embodiment, when multilayer bitstream is contained in a video track, the stereoscopic video scheme_type ‘stvi’ is extended to indicate that when stereo-coded video frames are decoded, the decoded frames either contain a representation of two spatially packed constituent frames that form a stereo pair (frame packing) or only one view of a stereo pair (left and right views in different tracks) or each view of the stereo pair may be present in a frame belonging to a specific layer (left and right views in different layers) of a multilayer video. Restrictions due to stereo-coded video are contained in the StereoVideoBox or in a new box defined below.

In an alternate embodiment, when multilayer bitstream is contained in a video track, a new stereoscopic multilayer video scheme_type ‘stmv’ is defined to indicate that when stereo-coded video frames are decoded, each view of the stereo pair may be present in a frame belonging to a specific layer of a multilayer video (left and right views in different layers). Restrictions due to multilayer stereo-coded video are contained in the StereoVideoBox or in a new box defined below.

In an embodiment, a new StereoMultiLayerVideobox is defined.

```
  aligned(8) class StereoMultilayerVideoBox extends FullBox(‘stmv’,
version = 0, 0)
  {
    unsigned int(8) num_layers;
    for (i=0; i<num_layers; i++) {
      bit(1) reserved = 0;
      unsigned int(6) layer_id;
      unsigned int(1) left_view_flag;
    }
  }
```

In an embodiment, the num_layers in StereoMultilayerVideoBox may be set to 2 indicating the presence of only the left view and the right view of the stereoscopic pair. In an alternate embodiment, the num_layers may be 3 indicating the presence of a monoscopic fall back view together with the left view and the right view of the stereoscopic pair. In an embodiment, the num_layers may be more than 3 when stereoscopic views may also include depth or alpha channels together with video.

In an embodiment, the left_view_flag when set to 1 indicates that the layer with layer id equal to layer_id has the left view of the stereoscopic pair. In an embodiment, the left_view_flag when set to 0 indicates that the layer with layer id equal to layer_id has the right view of the stereoscopic pair. In an embodiment, the left_view_flag field may be encoded with bit(2) or more to capture the presence of depth or alpha maps related to left view and right views respectively together with the monoscopic fallback view, in such a case a specific value of left_view_flag may indicate the presence of the specific content defined above.

In an alternate embodiment, the StereoVideoBox may be extended to indicate the presence of stereoscopic views in each layer by setting the stereo_scheme to for example 6 (which is currently a reserved value) where the stereo_scheme is an integer that indicates the stereo arrangement scheme used and the stereo indication type according to the used scheme. When the stereo_scheme is equal to 6 it indicates that stereoscopic video is present in a multilayer arrangement. The extension of the StereoVideoBox can also be achieved by having a version=1 or through the setting of a specific bit in the box flag. In an example embodiment, the extension to StereoVideoBox through any of the method described above should include information about which layer carries the right view, and which layer carries the left view of a stereoscopic pair. In an example embodiment, when stereo_scheme is equal to 6 the following structure may be present in the StereoVideoBox

```
{
  If(Stereo_scheme == 6){
    unsigned int(8) num_layers;
    for (i=0; i<num_layers; i++) {
      bit(1) reserved = 0;
      unsigned int(6) layer_id;
      unsigned int(1) left_view_flag;
    }
  }
}
```

In an alternate example embodiment, when stereo_scheme is equal to 6 the following structure may be present in the StereoVideoBox. 1) The value of length in StereoVideoBox may be set to 4 and stereo_indication_type set to unsigned int(32); and/or 2) Where the first two byte or the last two byte indicate the layer id of the left view or the right view of the stereoscopic pair.

In an embodiment, the LayerConfigurationBox may be extended further to indicate whether a given Sample auxiliary information belongs to a specific layer within a multilayer bitstream. In an example embodiment, LayerConfigurationBox may be extended as below:

```
{
  unsigned int(8) num_layers;
  for (i=0; i<num_layers; i++) {
    bit(2) reserved = 0;
    unsigned int(6) layer_id;
    unsigned int(32) aux_info_type;
    unsigned int(32) aux_info_type_parameter;
  }
}
```

aux_info_type is an integer that identifies the type of the sample auxiliary information.

aux_info_type_parameter identifies the “stream” of sample auxiliary information having the same value of aux_info_type and associated to the same track. The semantics of aux_info_type_parameter are determined by the value of aux_info_type.

In an embodiment, when multilayer bitstream is to be stored in a video track so that the track is backward compatible to legacy file parsers/file readers/players (i.e., file parsers/file readers which are only compatible with base layer processing and playback) then the encoded data related to base layer and the encoded data related to other layers may be split as follows: 1) The encoded data related to the base layer is stored in the samples of the track; and/or 2) The encoded data related to one or more non-base layers may be stored in the sample auxiliary information data boxes which are related to the samples of the track or one or more non-base layers may be stored in the additional split layers.

In an embodiment, samples of a track can be extended with several extents, for example, to enable interleaving of layers from a multilayer bitstream or to enable tiles/subpictures from a bitstream containing two or more tiles/subpictures (e.g., VVC subpictures).

In an embodiment, a sample extent is a contiguous subset of the bytes of the resource identified by an offset and a length. In an example embodiment, a multilayer bitstream may be stored in a track such that the encoded data of the base layer is in the samples of the track and the one or more samples are extended with one or more sample extents for the one or more additional layers. In an embodiment, a sample extent allows storing the data of media samples as non-contiguous pieces of data in a track.

In an embodiment, the one or more sample extents may be considered as part of the sample data when the data in the samples and the data in the sample extension is processed together. In an embodiment, a sample extent may contain a single video enhancement layer or several ones, or multiple tiles, or non-base layer part of a multilayer bitstream coded with a different codec from the base layer.

In an embodiment, sample extensions using sample extent whose offsets/sizes are described within any of the following: 1) SplitLayerBox in the SampleTableBox or TrackFragmentBox, or 2) SampleExtensionBox in the SampleTableBox or TrackFragmentBox, or 3) SampleExtensionBox or SplitLayerBox in the (SampleExtensionTableBox or TrackFragmentBox) or (SplitSampleTableBox or TrackFragmentBox).

In an embodiment, when data is stored as split-samples or in the sample extents as part of sample extension a new SplitSampleTableBox or SampleExtensionTableBox with 4cc equal to ‘sstb’ or ‘setb’ (or any other suitable name or 4cc value may be used) is defined. In an embodiment, SplitSampleTableBox or SampleExtensionTableBox, the split-sample table or the sample extension table contains all the time and data indexing of the split-samples or the sample extents in a track. In an embodiment, using the SplitSampleTableBox or SampleExtensionTableBox it is possible to locate split-samples or sample extents in time, determine their type (e.g., I-frame or not), and determine their size, container, and offset into that container.

In an embodiment, the SplitSampleTableBox or SampleExtensionTableBox is present in MedialnformationBox. In an embodiment, the SplitSampleTableBox or SampleExtensionTableBox is companion to SampleTableBox when split samples or Sample extents are present in a track.

In an embodiment, if the track that contains the SplitSampleTableBox or SampleExtensionTableBox references no data, then the SplitSampleTableBox or SampleExtensionTableBox does not need to contain any sub-boxes.

In an example embodiment, the SplitSampleTableBox or SampleExtensionTableBox is defined as below:

| | |
|---|---|
| Box Type: | ‘stbl’ |
| Container: | MediaInformationBox |

aligned(8) class SampleExtensionTableBox extends Box(‘setb’)
{
}
aligned(8) class SplitSampleTableBox extends Box(‘sstb’)
{
}

In an embodiment, a new SampleExtensionDescriptionBox is defined with 4cc ‘sesd’ (any other suitable name and 4cc value may be used). In an embodiment, the sample extension description table gives detailed information about the coding type used for each sample extent, and any initialization information needed for that coding. The syntax of the sample entry used is determined by both the format field and the media handler type.

In an embodiment, a SampleExtensionDescriptionBox provides for each sample extent one or more decoder configurations if desired, in the sample extension description of the track. It is a container box for sample entries describing each sample extent.

```
  aligned(8) class SampleExtensionDescriptionBox( )
    extends FullBox(‘sesd’, version, 0)
  {
    int i;
    unsigned int(32) entry_count;
    for (i = 1 ; i <= entry_count ; i++) {
      SampleEntry( ); // an instance of a class derived from
SampleEntry
    }
  }
```

entry_count is an integer that gives the number of entries in the SampleExtensionDescriptionBox table.

SampleEntry is the appropriate sample entry. SampleEntry describe the codecs and configuration information, if needed, for decoding each sample extent.

In an embodiment, the parameter entry_count within the SampleExtensionDescriptionBox may not be signaled but rather implied from the number of sample extents. In an alternate embodiment, allow only a single sample entry in SampleExtensionDescriptionBox for a specific sample extent and have multiple SampleExtensionDescriptionBox(es) in SampleExtensionTableBox or SplitSampleTableBox.

In an embodiment, the SampleExtensionDescriptionBox is a container box for a single sample extent. In an embodiment, the SplitSampleTableBox or SampleExtensionTableBox or trackFragmentbox consists of one or more SampleExtensionDescriptionBox(es). In an embodiment, each SampleExtensionDescriptionBox documents information needed to process single sample extent data or single split-layer data. In an embodiment, there are at least one SampleExtensionDescriptionBox within a SplitSampleTableBox or SampleExtensionTableBox or TrackFragmentbox. In an embodiment, the number of sample extents to be proceeded is determined by the number of SampleExtensionDescriptionBox(es).

aligned(8) class SampleExtensionDescriptionBox( )
extends Box (‘sesd’)
{
}

In an embodiment, the Sample entry required to decode a specific sample extent is present in the SampleExtensionDescriptionBox. In an embodiment, if the SampleExtensionDescriptionBox is present in a TrackFragmentbox is will not contain the SampleEntry of the specific sample extent but will contain other information required to process the sample extent in the track fragment.

In an embodiment, a new SampleExtensionConfigBox with 4cc value ‘saec’ is defined (any other suitable name and 4CC value may be used). In an embodiment, the SampleExtensionConfigBox may be present in the SampleExtensionDescriptionBox. In an embodiment, the SampleExtensionConfigBox indicates the information related to a specific sample extent. In an example embodiment, the SampleExtensionConfigBox is defined below:

```
aligned(8) class SampleExtensionConfigBox
  extends FullBox(‘saec’, 0, 0)
{
  unsigned int(1) SAI_applies_for_sample_extent_flag;
  bit(7) reserved;
}
```

SAI_applies_for_sample_extent_flag indicates, if set to 0, that sample auxiliary information directly declared in the SampleTableBox does not apply to the sample extent. If SAI_applies_for_sample_extent_flag is set to 1 it indicates that the sample auxiliary information directly declared in the SampleTableBox applies to the sample extent. SAI stands for Sample Auxiliary Information.

In an embodiment, if two or more Sample auxiliary information data is present in the SampleTableBox or TrackFragmentBox then the SampleExtensionConfigBox may be further extended to indicate which among the two or more Sample auxiliary information data applies to the said Sample extent by indicating the aux_info_type and the aux_info_type_parameter of the sample auxiliary information data.

In an embodiment, SampleExtensionConfigBox may be further extended to include information about which among the boxes present in the SampleEntry of the SampleDescriptionBox. For example, if the SampleEntry in the SampleDescriptionBox of the track contains any of the following boxes: 1) CleanApertureBox; 2) PixelAspectRatioBox; 3) ColorInformationBox; 4) ContentLightLevelBox; 5) MasteringDisplayColorVolumeBox; 6) ContentColorVolumeBox; and/or 7) AmbientViewingEnvironmentBox.

Then the SampleExtensionConfigBox indicates which among the boxes present in the SampleEntry of the SampleDescriptionBox belong to the specific sample extent. The indication may be signaled by defining the 4cc value of the box present in the SampleEntry of the SampleDescriptionBox alternatively the indication may be signaled by an index of the box starting with either index 0 or index 1 in the order the boxes are present in the SampleEntry of the SampleDescriptionBox.

In an embodiment, SampleExtensionConfigBox may be further extended to indicate which among the sample groups present in the SampleTableBox or the TrackFragmentBox of the track belong to the specific sample extent. The indication may be signaled defining the 4cc value of the sample group present in the SampleTableBox or the TrackFragmentBox of the track.

In an embodiment, the SampleExtensionDescriptionBox additionally describes the offsets/sizes and additional descriptive information, e.g. sample auxiliary information, of the sample extent. In an embodiment, for non-fragmented cases, the chunking is the same between all sample extents, i.e., a SampleToChunkBox is present only in the SampleTableBox. The ChunkOffsetBox or (ChunkLargeOffsetBox) and the SampleSizeBox (or CompactSampleSizeBox) in the SampleTableBox provides the locations of the chunks and sizes of the data of the track samples only. It is allowed to have a chunk size of 0 if all data for the samples of the chunk are in sample extents.

In an embodiment, the TimeToSampleBox, CompositionToDecodeBox and SyncSampleBox in SampleTableBox are defined for the aggregate of all sample extents together with the samples of the track.

In an embodiment, the SampleExtensionDescriptionBox comprises a SampleSizeBox (or CompactSampleSizeBox) and a ChunkOffsetBox (or ChunkLargeOffsetBox) describing the locations of the chunks and sizes of the data of the sample extent.

In an embodiment, it is allowed to have a sample size of 0 in the SampleSizeBox (or CompactSampleSizeBox) if there is no data for the given sample extent.

In an embodiment, The SampleSizeBox (or CompactSampleSizeBox) included in each SampleExtensionDescriptionBox will have the same sample count as the SampleSizeBox (or CompactSampleSizeBox) in the SampleTableBox of the track.

In an embodiment, if ChunkOffsetBox (or ChunkLargeOffsetBox) is absent in a SampleExtensionDescriptionBox, the chunk offset for this sample extent is equal to the chunk offset of the preceding sample extent described by the preceding SampleExtensionDescriptionBox, if any in the SampleExtensionTableBox, or, by default, is equal to the chunk offset of the track samples plus the total size of the sample extents for the preceding sample extent in the chunk. Otherwise ChunkOffsetBox (or ChunkLargeOffsetBox) is present in a SampleExtensionDescriptionBox, there will be as many entries as there are entries in the ChunkOffsetBox (or ChunkLargeOffsetBox) for the samples of the track (present in the SampleTableBox).

In an embodiment, for fragmented case, the sample chunking is used as for the samples of the track fragment. In an embodiment, the TrackFragmentBox comprises a SampleExtensionDescriptionBox for each sample extent. In an embodiment, for the sample extents, a simplified version of track runs, SampleExtensionTrackRunBox, is used to describe sample extent sizes and optionally offsets. In an embodiment, the SampleExtensionTrackRunBox describes the sizes and optionally offsets for the data in a sample extent. In an embodiment, in a track fragment box, the SampleExtensionDescriptionBox may have as many SampleExtensionTrackRunBox as there are TrackRunBox in the track fragment box.

In an embodiment, a new SampleExtensionTrackRunBox with 4vv value ‘srun’ is defined (any other suitable name and 4cc value may be used). In an example embodiment, the SampleExtensionTrackRunBox is defined as below.

```
aligned(8) class SampleExtensionTrackRunBox extends FullBox(‘srun’,
0, 0) {
  signed int(32) data_offset;
  {
    unsigned int(32) sample_size;
  } [ sample_count ]
}
```

sample_count the number of samples being added in this run; also the number of rows in the following table (the rows can be empty). sample_count is the sample_count from the TrackRunBox describing the samples in the same track fragment box.

data_offset is added to the implicit or explicit base_data_offset established in the track fragment header.

In an embodiment, an aggregate bitstream (for example multilayer bitstream) can be obtained by aggregating the data of the sample extents following the reconstruction process described by SplitSamplesConfigurationBox or the SampleExtentsAggregateBox.

In an embodiment, the SplitSamplesConfigurationBox or the SampleExtentsAggregateBox is present in the SampleExtensionTableBox.

In an embodiment, the SampleExtentsAggregateBox is defined with 4cc ‘seag’ (any other suitable name and 4cc may be used). The SampleExtentsAggregateBox is present in the SampleExtensionTableBox or SplitSampleTableBox. In an embodiment, the SampleExtentsAggregateBox provides parameters for defining the reconstruction process to aggregate the data from sample extents and the samples of the track. In an embodiment, the default reconstruction process is to aggregate data from the samples of the track and data from each of the sample extents in the order they are defined in the SampleExtensionTableBox or in the order specified in the SampleExtensionConfigBox.

In an embodiment, the SampleExtentsAggregateBox allows describing alternative possible reconstruction processes, if any.

```
SampleExtentsAggregateBox extends FullBox(‘seag’, 0, 0)
{
  bit(1) all_sample_extents_independent;
  bit(1) no_default_sample_extent_aggregation;
  bit(1) other_sample_extent_aggregations;
  bit(5) reserved;
  if (other_sample_extent_aggregations) {
    unsigned int(32 num_sample_extent_aggregations;
    [
      unsigned int(32) nb_sample_extents;
      unsigned int(32) sample_extent_index[nb_sample_extents];
      unsigned int(32) num_configurations;
      unsigned int(32) sample_extent_sesd_idx[num_configurations];
    ](num_sample_extent_aggregations)
  }
}
```

all_sample_extents_independent indicates, if set to 1, that all sample extents are independent and could be processed independently.

no_default_sample_extent_aggregation indicates, if set to 1, that the default sample extent aggregation is not possible. The default sample extent aggregation consists of appending to the sample data of the track the sample extent data in the order the sample extensions are described in the SampleDescriptionsBox(es) within the SampleExtensionTableBox.

other_sample_extent_aggregations indicates, if set to 1, that other sample extents aggregations than the default one are possible.

NOTE If no_default_sample_extent_aggregation is set to 1 indicating that there is no default sample extent aggregation of the sample extents in the reconstruction process and other_sample_extent_aggregations is set to 0 indicating that there is no other sample extent aggregation rules in the reconstruction process, this indicates to the parser that the sample extents are not intended to be aggregated.

num_sample_extent_aggregations indicates the number of additional possible sample extent aggregations.

nb_sample_extents indicates the number of sample extents in an aggregation.

sample_extent_index indicates the index of the sample extent to aggregate, with the value 0 being the track sample data.

num_configurations gives the number of sample extent entries used by this reconstruction.

sample_extent_sesd_idx is the index of a sample entry used by this aggregation, the value 0 meaning the track sample entry, the value 1 being the sample entry in the first SampleExtensionDescriptionsBox. This value shall not be greater than the number of SampleExtensionDescriptionsBox(es). Any codec specific data (parameter sets or equivalent for non-video media types) present in this entry shall be forwarded to the decoder in the order of appearance in this list. The last entry shall indicate the highest codec requirements for the aggregation, e.g. highest profile-tier-level in video coding.

In an embodiment, seeking is accomplished primarily by using the child boxes contained in the SampleTableBox. When sample extents are present in the track seeking additionally uses the child boxes contained in the SampleExtensionTableBox

Operating point related information is described now. In an embodiment, operating points represented by a track are described in a box, which may be referred to as OperatingPointBox. The options to select a container box of OperatingPointBox may be the same as for the LayerConfigurationBox. Multiple OperatingPointBoxes may be present, each describing a different operating point represented by the track.

An OperatingPointBox may comprise, but may not be limited to, information indicative of one or more of the following.

1) An operating point identifier or index.

2) Layers included in the operating point, which may be indicated, for example, through layer identifiers or layer indexes. These layers may include both layers that are needed for decoding but are not output, and layers that are both decoded and output by decoding the operating point.

3) Output layers resulting from decoding the operating point.

4) Primary output layer, which specifies the output layer of all the output layers of this operating point that is to be used in case an application does not support multiple output layers.

5) Temporal sublayers included in the operating point, which may be indicated, for example, through the greatest temporal identifier included in the operating point.

6) Coding format specific data to be provided to a decoder through an interface to cause the decoder to decode the operating point described by this OperatingPointBox. For example: a) Operating point index for an AV1 track; b) Output layer set index (TargetOlsIdx) and the highest temporal identifier (Htid) for a VVC track.

7) Coding format specific data to be included in a bitstream reconstructed from the track to cause the decoder to decode the operating point described by this OperatingPointBox. For example: An operating point information NAL unit for a VVC track.

In an example embodiment, OperatingPointBox has the following syntax:

```
aligned(8) class OperatingPointBox
  extends FullBox(‘oprp’, version=0, flags=0)
{
  unsigned int(8) num_layers;
  for (i=0; i<num_layers; i++) {
    unsigned int(6) layer_id;
    unsigned int(1) output_flag;
    unsigned int(1) primary_output_flag;
  }
  unsigned int(3) highest_tid;
  bit(5) reserved = 0;
  unsigned int(8) num_codec_interface_bytes;
  if (num_codec_interface_bytes)
    unsigned int(8)
    codec_interface_data[num_codec_interface_bytes];
  unsigned int(8) num_codec_bitstream_bytes;
  if (num_codec_bitstream_bytes)
    unsigned int(8)
      codec_bitstream_data[num_codec_bitstream_bytes];
}
```

In an embodiment, the codecs string and the mime type associated with a track may be signaled in a file format structure at the track level or at the file level. In an embodiment, a new entity group box with grouping_type ‘mime’ may be defined which describes the mime type and codec string of all the entities in the file. In an embodiment, a new MimeTypeBox is defined with 4cc ‘mime’ (any other suitable name and 4cc may be used) the MimeTypeBox defines the mime type of the track in the file. The MimeTypeBox may be present in the TrackBox as a companion to trackHeaderBox alternative the TrackHeaderBox or the TrackTypeBox may be extended with a new version to include the mime type and the codecs string associated with the track. In an embodiment, the mime type of an item may be signaled in a new item property called the MimeTypePropertyBox associated with an item. The MimeTypePropertyBox defines the mime type of the item.

In an example embodiment, the MimeTypeBox or the MimeTypeEntityGroup or the MimeTypPropertyBox may define the mime type of the entity as follows:

```
{
  utf8string codecs;
  utf8string extended_description;
}
```

The codecs string defines the mime type of the entity based on RFC 6381. It specifies the original codecs string the PTL information of an operating point used. for example as follows: codecs=“hvc1.1.6.L93.B0”.

In an embodiment, the extended description may contain additional details related to the content present in the track. It may specify the intended use case of the media. For example: videoalpha: The resource contains a video with alpha.

stereovideo: The resource contains a stereo video pair.

More use-cases can be defined here. We could also define entries such that its clear if layered codec is used or if packing is used, and the like.

Color description information (CICP, coding independent code points) is described now.

Either as a pre-defined string, e.g., bt709 or as a combination of CICP values transfer_charactersitics, matrix_coeff, color_primaries: color=bt2020hlg, Or alternatively we can use CICP, color=9.18.9. Examples: codecs=“need.usecase=videoalpha+codec=hvc1.1.6.L93.B0”, as an alternative: codecs=“hvc1.1.6.L93.B0”, extended_description=“usecase=videoalpha”.

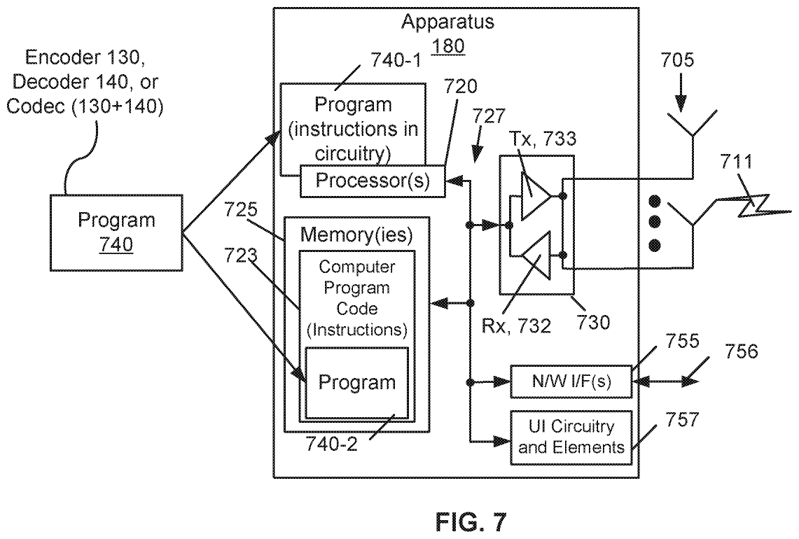

Turning to FIG. 7, this figure is an example of a block diagram of an apparatus 180 suitable for implementing any of the encoders or decoders described herein. The apparatus 180 includes circuitry comprising one or more processors 720, one or more memories 725, one or more transceivers 730, one or more network (N/W) interface(s) (I/F(s)) 755 and user interface (UI) circuitry and elements 757, interconnected through one or more buses 727. Depending on implementation, some apparatus may not have all of the circuitry. For example, an apparatus 180 might not have UI circuitry and elements 757. An apparatus may have additional circuitry, not described here. FIG. 7 is presented merely as an example.

Each of the one or more transceivers 730 includes a receiver, Rx, 732 and a transmitter, Tx, 733. The one or more buses 727 may be address, data, and/or control buses, and may include any interconnection mechanism, such as a series of lines on a motherboard or integrated circuit, fiber optics or other optical communication equipment, and the like. The one or more transceivers 730 are connected to one or more antennas 705, and may communicate using wireless link 711, which could implement any number of wireless communication interfaces such as Wi-Fi, cellular, or satellite.

The one or more memories 725 include computer program code 723. The apparatus 180 includes a program 740, comprising one of or both parts 740-1 and/or 740-2. The program 740 may implement an encoder 130, a decoder 140, or a codec (130+140), which implements both encoding and decoding. The program itself may be implemented in a number of ways. The program 740 may be implemented in circuitry as program 740-1, such as being implemented as part of the one or more processors 720, and contains instructions implemented in circuitry. The program 740-1 may be implemented also as an integrated circuit or through other circuitry such as a programmable gate array. In another example, the program 740 may be implemented as program 740-2, which is implemented as computer program code (having corresponding instructions) 723 and is executed by the one or more processors 720. For instance, the one or more memories 725 store instructions that, when executed by the one or more processors 720, cause the apparatus 180 to perform one or more of the operations as described herein.

The network interface(s) (N/W I/F(s)) 755 are wired interfaces communicating using link(s) 756, which could be fiber optic or other wired interfaces. The apparatus 180 could include only wireless transceiver(s) 730, only N/W I/Fs 755, or both wireless transceiver(s) 730 and N/W I/Fs 755.

The apparatus 180 may or may not include UI circuitry and elements 757. These could include a display such as a touchscreen, speakers, or interface elements such as for headsets. For instance, an apparatus 180 of a smartphone would typically include at least a touchscreen and speakers. The UI circuitry and elements 757 may also include circuitry to communicate with external UI elements (not shown) such as displays, keyboards, mice, headsets, and the like.

The computer readable memories 725 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The processor(s) 720 may be of any type suitable to the local technical environment, and may include one or more of general-purpose computers, special purpose computers, microprocessors, digital signal processors (DSPs) and processors based on a multi-core processor architecture, as non-limiting examples. The processor(s) 720 control the apparatus 180 to perform the operations as described herein. The processor(s) 720 may execute instructions, including microcode, but are not implemented solely in software.

As used in this application, the term “circuitry” may refer to one or more or all of the following: (a) hardware-only circuit implementations (such as implementations in analog, digital, and/or quantum circuitry) and (b) combinations of hardware circuits and software such as (as applicable): (i) a combination of analog, digital, and/or quantum hardware circuit(s) with software/firmware and (ii) any or all portions of hardware processor(s) (including digital and/or quantum processor(s)) with software, and memory(ies) that work together to cause an apparatus, such as a mobile device, computing device, or server, to perform various functions) and (c) any or all portions of hardware circuit(s), such as microprocessor(s), processor(s) and/or quantum processors, that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In an example embodiment, software (e.g., application logic, an instruction set) as used herein is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 7. A computer-readable medium may comprise a computer-readable storage medium (e.g., memories 725 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

The following are additional examples.

Example 1. A method, comprising: in a process for coding a multilayer bitstream into a box structured file having video information from video, placing supplemental information into a box of the box structured file, where the box stores metadata for the video information, and where the supplemental information can be used to process two or more output frames per time instance of the video from a track of the box structured file; and outputting the box structured file at least as an encapsulated file. Example 2. The method according to example 1, wherein the supplemental information comprises a field in a sample entry of the track of the box structured file, wherein a value of the field being equal to a specific value indicates that each sample of the track can contain more than one frame with a maximum number equal to a number of layers in the multilayer bitstream. Example 3. The method according to example 1, wherein the supplemental information comprises a field in a sample entry of the track of the box structured file, wherein a value of the field is set equal to a maximum number of layers in the multilayer bitstream indicating that samples of the track contain frames from zero and up to the maximum number of layers. Example 4. The method according to any of examples 1 to 3, wherein the track of the box structured file comprises a video track having information related to the multilayer bitstream, wherein the box contains a first box having information related to one or more layers present in the video track, and wherein the first box is present in one of the following: a track box defining the information related to the multilayer bitstream in the video track; a track header box that is extended from a base class of a full box, and that has one or more parameters to hold the information related to the multilayer bitstream; a media box that is a track media structure; a media information box that declares characteristics information of media in the video track; a sample table box; a sample entry of the track or a visual sample entry in case of the video track; a split samples configuration box when split layers of the multilayer bitstream are used; a sample entry of a split sample descriptions box when split layers of the multilayer bitstream are used; or an SAI (Sample Auxiliary Information) header box when auxiliary samples are used. Example 5. The method according to any of examples 1 to 3, wherein the track comprises a video track containing at least part of the multilayer bitstream, and when the video track contains a pixel aspect ratio sample group, a pixel aspect ratio of only a base layer is signaled in samples of the video track. Example 6. The method according to any of examples 1 to 3, wherein the track comprises a video track containing at least part of the multilayer bitstream, and when the video track contains a pixel aspect ratio sample group, a pixel aspect ratio of all layers are signaled in samples of the video track. Example 7. The method according to any of examples 1 to 3, wherein the track comprises a video track containing at least part of the multilayer bitstream, and the supplemental information comprises a scheme type indicating that, when multilayer video frames are decoded, decoded ones of the multilayer video frames contain frames from different layers. Example 8. The method according to example 7, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair. Example 9. The method according to example 7 or 8, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream.

Example 10. A method, comprising: in a process for parsing a box structured file into a multilayered bitstream, where the box structured file has video information from video, accessing supplemental information from a box, in the box structured file, storing metadata for the video information, where the supplemental information can be used to process two or more output frames per time instance of the video from a track of the box structured file; and processing the two or more output frames per time instance of the video information from the track based at least on the supplemental information in the box to form video information for outputting decoded video. Example 11. The method according to example 10, wherein the supplemental information comprises a field in a sample entry of the track of the box structured file, wherein a value of the field being equal to a specific value indicates that each sample of the track can contain more than one frame with a maximum number equal to a number of layers in the multilayer bitstream. Example 12. The method according to example 10, wherein the supplemental information comprises a field in a sample entry of the track of the box structured file, wherein a value of the field is set equal to a maximum number of layers in the multilayer bitstream indicating that samples of the track contain frames from zero and up to the maximum number of layers. Example 13. The method according to any of examples 10 to 12, wherein the track of the box structured file comprises a video track having information related to the multilayer bitstream, wherein the box contains a first box having information related to one or more layers present in the video track, and wherein the first box is present in one of the following: a track box defining the information related to the multilayer bitstream in the video track; a track header box that is extended from a base class of a full box, and that has one or more parameters to hold the information related to the multilayer bitstream; a media box that is a track media structure; a media information box that declares characteristics information of media in the video track; a sample table box; a sample entry of the track or a visual sample entry in case of the video track; a split samples configuration box when split layers of the multilayer bitstream are used; a sample entry of a split sample descriptions box when split layers of the multilayer bitstream are used; or an SAI (Sample Auxiliary Information) header box when auxiliary samples are used. Example 14. The method according to any of examples 10 to 12, wherein the track comprises a video track containing at least part of the multilayer bitstream, and when the video track contains a pixel aspect ratio sample group, a pixel aspect ratio of only a base layer is signaled in samples of the video track. Example 15. The method according to any of examples 10 to 12, wherein the track comprises a video track containing at least part of the multilayer bitstream, and when the video track contains a pixel aspect ratio sample group, a pixel aspect ratio of all layers of the multilayer bitstream are signaled in samples of the video track. Example 16. The method according to any of examples 10 to 12, wherein the track comprises a video track containing at least part of the multilayer bitstream, and the supplemental information comprises a scheme type indicating that, when multilayer video frames are decoded, decoded ones of the multilayer video frames contain frames from different layers. Example 17. The method according to example 16, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair. Example 18. The method according to example 16 or 17, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream. Example 19. The method according to any of examples 10 to 18, wherein the video information corresponds to individual layers of a decoder having multiple layers for decoding, and the processing the two or more output frames per time instance of the video information comprises processing the two or more output frames per time instance in order to send, to the decoder, video information for the individual layers of the decoder.

Example 20. An apparatus, comprising means for: in a process for coding a multilayer bitstream into a box structured file having video information from video, placing supplemental information into a box of the box structured file, where the box stores metadata for the video information, and where the supplemental information can be used to process two or more output frames per time instance of the video from a track of the box structured file; and outputting the box structured file at least as an encapsulated file. Example 21. The apparatus according to example 20, wherein the supplemental information comprises a field in a sample entry of the track of the box structured file, wherein a value of the field being equal to a specific value indicates that each sample of the track can contain more than one frame with a maximum number equal to a number of layers in the multilayer bitstream. Example 22. The apparatus according to example 20, wherein the supplemental information comprises a field in a sample entry of the track of the box structured file, wherein a value of the field is set equal to a maximum number of layers in the multilayer bitstream indicating that samples of the track contain frames from zero and up to the maximum number of layers. Example 23. The apparatus according to any of examples 20 to 22, wherein the track of the box structured file comprises a video track having information related to the multilayer bitstream, wherein the box contains a first box having information related to one or more layers present in the video track, and wherein the first box is present in one of the following: a track box defining the information related to the multilayer bitstream in the video track; a track header box that is extended from a base class of a full box, and that has one or more parameters to hold the information related to the multilayer bitstream; a media box that is a track media structure; a media information box that declares characteristics information of media in the video track; a sample table box; a sample entry of the track or a visual sample entry in case of the video track; a split samples configuration box when split layers of the multilayer bitstream are used; a sample entry of a split sample descriptions box when split layers of the multilayer bitstream are used; or an SAI (Sample Auxiliary Information) header box when auxiliary samples are used. Example 24. The apparatus according to any of examples 20 to 22, wherein the track comprises a video track containing at least part of the multilayer bitstream, and when the video track contains a pixel aspect ratio sample group, a pixel aspect ratio of only a base layer is signaled in samples of the video track. Example 25. The apparatus according to any of examples 20 to 22, wherein the track comprises a video track containing at least part of the multilayer bitstream, and when the video track contains a pixel aspect ratio sample group, a pixel aspect ratio of all layers are signaled in samples of the video track. Example 26. The apparatus according to any of examples 20 to 22, wherein the track comprises a video track containing at least part of the multilayer bitstream, and the supplemental information comprises a scheme type indicating that, when multilayer video frames are decoded, decoded ones of the multilayer video frames contain frames from different layers. Example 27. The apparatus according to example 26, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair. Example 28. The apparatus according to example 26 or 27, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream.

Example 29. An apparatus, comprising means for: in a process for parsing a box structured file into a multilayered bitstream, where the box structured file has video information from video, accessing supplemental information from a box, in the box structured file, storing metadata for the video information, where the supplemental information can be used to process two or more output frames per time instance of the video from a track of the box structured file; and processing the two or more output frames per time instance of the video information from the track based at least on the supplemental information in the box to form video information for outputting decoded video. Example 30. The apparatus according to example 29, wherein the supplemental information comprises a field in a sample entry of the track of the box structured file, wherein a value of the field being equal to a specific value indicates that each sample of the track can contain more than one frame with a maximum number equal to a number of layers in the multilayer bitstream. Example 31. The apparatus according to example 29, wherein the supplemental information comprises a field in a sample entry of the track of the box structured file, wherein a value of the field is set equal to a maximum number of layers in the multilayer bitstream indicating that samples of the track contain frames from zero and up to the maximum number of layers. Example 32. The apparatus according to any of examples 29 to 31, wherein the track of the box structured file comprises a video track having information related to the multilayer bitstream, wherein the box contains a first box having information related to one or more layers present in the video track, and wherein the first box is present in one of the following: a track box defining the information related to the multilayer bitstream in the video track; a track header box that is extended from a base class of a full box, and that has one or more parameters to hold the information related to the multilayer bitstream; a media box that is a track media structure; a media information box that declares characteristics information of media in the video track; a sample table box; a sample entry of the track or a visual sample entry in case of the video track; a split samples configuration box when split layers of the multilayer bitstream are used; a sample entry of a split sample descriptions box when split layers of the multilayer bitstream are used; or an SAI (Sample Auxiliary Information) header box when auxiliary samples are used. Example 33. The apparatus according to any of examples 29 to 31, wherein the track comprises a video track containing at least part of the multilayer bitstream, and when the video track contains a pixel aspect ratio sample group, a pixel aspect ratio of only a base layer is signaled in samples of the video track. Example 34. The apparatus according to any of examples 29 to 31, wherein the track comprises a video track containing at least part of the multilayer bitstream, and when the video track contains a pixel aspect ratio sample group, a pixel aspect ratio of all layers of the multilayer bitstream are signaled in samples of the video track.

Example 35. The apparatus according to any of examples 29 to 31, wherein the track comprises a video track containing at least part of the multilayer bitstream, and the supplemental information comprises a scheme type indicating that, when multilayer video frames are decoded, decoded ones of the multilayer video frames contain frames from different layers. Example 36. The apparatus according to example 35, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair. Example 37. The apparatus according to example 35 or 36, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream. Example 38. The apparatus according to any of examples 29 to 37, wherein the video information corresponds to individual layers of a decoder having multiple layers for decoding, and the processing the two or more output frames per time instance of the video information comprises processing the two or more output frames per time instance in order to send, to the decoder, video information for the individual layers of the decoder.

Example 39. An apparatus, comprising: one or more processors; and one or more memories storing instructions that, when executed by the one or more processors, cause the apparatus at least to perform: in a process for coding a multilayer bitstream into a box structured file having video information from video, placing supplemental information into a box of the box structured file, where the box stores metadata for the video information, and where the supplemental information can be used to process two or more output frames per time instance of the video from a track of the box structured file; and outputting the box structured file at least as an encapsulated file. Example 40. The apparatus according to example 39, wherein the supplemental information comprises a field in a sample entry of the track of the box structured file, wherein a value of the field being equal to a specific value indicates that each sample of the track can contain more than one frame with a maximum number equal to a number of layers in the multilayer bitstream. Example 41. The apparatus according to example 39, wherein the supplemental information comprises a field in a sample entry of the track of the box structured file, wherein a value of the field is set equal to a maximum number of layers in the multilayer bitstream indicating that samples of the track contain frames from zero and up to the maximum number of layers. Example 42. The apparatus according to any of examples 39 to 41, wherein the track of the box structured file comprises a video track having information related to the multilayer bitstream, wherein the box contains a first box having information related to one or more layers present in the video track, and wherein the first box is present in one of the following: a track box defining the information related to the multilayer bitstream in the video track; a track header box that is extended from a base class of a full box, and that has one or more parameters to hold the information related to the multilayer bitstream; a media box that is a track media structure; a media information box that declares characteristics information of media in the video track; a sample table box; a sample entry of the track or a visual sample entry in case of the video track; a split samples configuration box when split layers of the multilayer bitstream are used; a sample entry of a split sample descriptions box when split layers of the multilayer bitstream are used; or an SAI (Sample Auxiliary Information) header box when auxiliary samples are used. Example 43. The apparatus according to any of examples 39 to 41, wherein the track comprises a video track containing at least part of the multilayer bitstream, and when the video track contains a pixel aspect ratio sample group, a pixel aspect ratio of only a base layer is signaled in samples of the video track. Example 44. The apparatus according to any of examples 39 to 41, wherein the track comprises a video track containing at least part of the multilayer bitstream, and when the video track contains a pixel aspect ratio sample group, a pixel aspect ratio of all layers are signaled in samples of the video track. Example 45. The apparatus according to any of examples 39 to 41, wherein the track comprises a video track containing at least part of the multilayer bitstream, and the supplemental information comprises a scheme type indicating that, when multilayer video frames are decoded, decoded ones of the multilayer video frames contain frames from different layers. Example 46. The apparatus according to example 45, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair. Example 47. The apparatus according to example 45 or 46, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream.

Example 48. An apparatus, comprising: one or more processors; and one or more memories storing instructions that, when executed by the one or more processors, cause the apparatus at least to perform: in a process for parsing a box structured file into a multilayered bitstream, where the box structured file has video information from video, accessing supplemental information from a box, in the box structured file, storing metadata for the video information, where the supplemental information can be used to process two or more output frames per time instance of the video from a track of the box structured file; and processing the two or more output frames per time instance of the video information from the track based at least on the supplemental information in the box to form video information for outputting decoded video. Example 49. The apparatus according to example 48, wherein the supplemental information comprises a field in a sample entry of the track of the box structured file, wherein a value of the field being equal to a specific value indicates that each sample of the track can contain more than one frame with a maximum number equal to a number of layers in the multilayer bitstream. Example 50. The apparatus according to example 48, wherein the supplemental information comprises a field in a sample entry of the track of the box structured file, wherein a value of the field is set equal to a maximum number of layers in the multilayer bitstream indicating that samples of the track contain frames from zero and up to the maximum number of layers. Example 51. The apparatus according to any of examples 48 to 50, wherein the track of the box structured file comprises a video track having information related to the multilayer bitstream, wherein the box contains a first box having information related to one or more layers present in the video track, and wherein the first box is present in one of the following: a track box defining the information related to the multilayer bitstream in the video track; a track header box that is extended from a base class of a full box, and that has one or more parameters to hold the information related to the multilayer bitstream; a media box that is a track media structure; a media information box that declares characteristics information of media in the video track; a sample table box; a sample entry of the track or a visual sample entry in case of the video track; a split samples configuration box when split layers of the multilayer bitstream are used; a sample entry of a split sample descriptions box when split layers of the multilayer bitstream are used; or an SAI (Sample Auxiliary Information) header box when auxiliary samples are used. Example 52. The apparatus according to any of examples 48 to 50, wherein the track comprises a video track containing at least part of the multilayer bitstream, and when the video track contains a pixel aspect ratio sample group, a pixel aspect ratio of only a base layer is signaled in samples of the video track. Example 53. The apparatus according to any of examples 48 to 50, wherein the track comprises a video track containing at least part of the multilayer bitstream, and when the video track contains a pixel aspect ratio sample group, a pixel aspect ratio of all layers of the multilayer bitstream are signaled in samples of the video track.

Example 54. The apparatus according to any of examples 48 to 50, wherein the track comprises a video track containing at least part of the multilayer bitstream, and the supplemental information comprises a scheme type indicating that, when multilayer video frames are decoded, decoded ones of the multilayer video frames contain frames from different layers. Example 55. The apparatus according to example 54, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair. Example 56. The apparatus according to example 54 or 55, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream. Example 57. The apparatus according to any of examples 48 to 56, wherein the video information corresponds to individual layers of a decoder having multiple layers for decoding, and the processing the two or more output frames per time instance of the video information comprises processing the two or more output frames per time instance in order to send, to the decoder, video information for the individual layers of the decoder.

Example 58. A computer program, comprising instructions which, when the program is executed by an apparatus, cause the apparatus to carry out the methods of any of examples 1 to 19. Example 59. The computer program according to example 58, wherein the computer program is a computer program product comprising a computer-readable medium bearing the instructions embodied therein for use with the apparatus. Example 60. The computer program according to example 58, wherein the computer program is directly loadable into an internal memory of the apparatus.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
in a process for parsing a box structured file into a multilayered bitstream, where the box structured file has video information from video, accessing supplemental information from a box, in the box structured file, storing metadata for the video information, where the supplemental information can be used to process two or more output frames per time instance of the video from a track of the box structured file; and
processing the two or more output frames per time instance of the video information from the track based at least on the supplemental information in the box to form video information for outputting decoded video.

2. An apparatus, comprising:
one or more processors; and
one or more memories storing instructions that, when executed by the one or more processors, cause the apparatus at least to perform:
in a process for coding a multilayer bitstream into a box structured file having video information from video, placing supplemental information into a box of the box structured file, where the box stores metadata for the video information, and where the supplemental information can be used to process two or more output frames per time instance of the video from a track of the box structured file; and
outputting the box structured file at least as an encapsulated file.

3. The apparatus according to claim 2, wherein the supplemental information comprises a field in a sample entry of the track of the box structured file, wherein a value of the field being equal to a specific value indicates that each sample of the track can contain more than one frame with a maximum number equal to a number of layers in the multilayer bitstream.

4. The apparatus according to claim 2, wherein the supplemental information comprises a field in a sample entry of the track of the box structured file, wherein a value of the field is set equal to a maximum number of layers in the multilayer bitstream indicating that samples of the track contain frames from zero and up to the maximum number of layers.

5. The apparatus according to claim 2, wherein the track of the box structured file comprises a video track having information related to the multilayer bitstream, wherein the box contains a first box having information related to one or more layers present in the video track, and wherein the first box is present in one of the following:
a track box defining the information related to the multilayer bitstream in the video track;
a track header box that is extended from a base class of a full box, and that has one or more parameters to hold the information related to the multilayer bitstream;
a media box that is a track media structure;
a media information box that declares characteristics information of media in the video track;
a sample table box;
a sample entry of the track or a visual sample entry in case of the video track;
a split samples configuration box when split layers of the multilayer bitstream are used;
a sample entry of a split sample descriptions box when split layers of the multilayer bitstream are used; or
an SAI (Sample Auxiliary Information) header box when auxiliary samples are used.

6. The apparatus according to claim 2, wherein the track comprises a video track containing at least part of the multilayer bitstream, and when the video track contains a pixel aspect ratio sample group, a pixel aspect ratio of only a base layer is signaled in samples of the video track.

7. The apparatus according to claim 2, wherein the track comprises a video track containing at least part of the multilayer bitstream, and when the video track contains a pixel aspect ratio sample group, a pixel aspect ratio of all layers are signaled in samples of the video track.

8. The apparatus according to claim 2, wherein the track comprises a video track containing at least part of the multilayer bitstream, and the supplemental information comprises a scheme type indicating that, when multilayer video frames are decoded, decoded ones of the multilayer video frames contain frames from different layers.

9. The apparatus according to claim 8, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair.

10. The apparatus according to claim 8, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream.

11. An apparatus, comprising:
one or more processors; and
one or more memories storing instructions that, when executed by the one or more processors, cause the apparatus at least to perform:
in a process for parsing a box structured file into a multilayered bitstream, where the box structured file has video information from video, accessing supplemental information from a box, in the box structured file, storing metadata for the video information, where the supplemental information can be used to process two or more output frames per time instance of the video from a track of the box structured file; and
processing the two or more output frames per time instance of the video information from the track based at least on the supplemental information in the box to form video information for outputting decoded video.

12. The apparatus according to claim 11, wherein the supplemental information comprises a field in a sample entry of the track of the box structured file, wherein a value of the field being equal to a specific value indicates that each sample of the track can contain more than one frame with a maximum number equal to a number of layers in the multilayer bitstream.

13. The apparatus according to claim 11, wherein the supplemental information comprises a field in a sample entry of the track of the box structured file, wherein a value of the field is set equal to a maximum number of layers in the multilayer bitstream indicating that samples of the track contain frames from zero and up to the maximum number of layers.

14. The apparatus according to claim 11, wherein the track of the box structured file comprises a video track having information related to the multilayer bitstream, wherein the box contains a first box having information related to one or more layers present in the video track, and wherein the first box is present in one of the following:
a track box defining the information related to the multilayer bitstream in the video track;
a track header box that is extended from a base class of a full box, and that has one or more parameters to hold the information related to the multilayer bitstream;
a media box that is a track media structure;
a media information box that declares characteristics information of media in the video track;
a sample table box;
a sample entry of the track or a visual sample entry in case of the video track;
a split samples configuration box when split layers of the multilayer bitstream are used;
a sample entry of a split sample descriptions box when split layers of the multilayer bitstream are used; or
an SAI (Sample Auxiliary Information) header box when auxiliary samples are used.

15. The apparatus according to claim 11, wherein the track comprises a video track containing at least part of the multilayer bitstream, and when the video track contains a pixel aspect ratio sample group, a pixel aspect ratio of only a base layer is signaled in samples of the video track.

16. The apparatus according to claim 11, wherein the track comprises a video track containing at least part of the multilayer bitstream, and when the video track contains a pixel aspect ratio sample group, a pixel aspect ratio of all layers of the multilayer bitstream are signaled in samples of the video track.

17. The apparatus according to claim 11, wherein the track comprises a video track containing at least part of the multilayer bitstream, and the supplemental information comprises a scheme type indicating that, when multilayer video frames are decoded, decoded ones of the multilayer video frames contain frames from different layers.

18. The apparatus according to claim 17, wherein where each layer contains video with different quality or resolution or bit-depth; or a combination of different quality or resolution or bit-depth; or each layer of the multilayer bitstream forms a part of a stereoscopic pair; or each layer of the multilayer bitstream includes video from different viewpoints; or each layer of the multilayer bitstream is a part of a video and depth pair or a video and alpha pair or a combination of the video and depth pair and the video and alpha pair.

19. The apparatus according to claim 17, wherein the box comprises multiple boxes, and wherein information related to multilayer coding is present in a layer configuration box, where the layer configuration box is present in a scheme information box when the scheme type indicates that, when the multilayer video frames are decoded, the decoded ones of the multilayer video frames contain frames from different layers of the multilayer bitstream.

20. The apparatus according to claim 11, wherein the video information corresponds to individual layers of a decoder having multiple layers for decoding, and the processing the two or more output frames per time instance of the video information comprises processing the two or more output frames per time instance in order to send, to the decoder, video information for the individual layers of the decoder.
